(19) United States
(12) Patent Application Publication
(10) Pub. No.: US 2025/0026678 A1
(43) Pub. Date: Jan. 23, 2025

(54) ALUMINOSILICATE OR ALUMINOBOROSILICATE GLASS COMPOSITION AND PRODUCTS COMPRISING THE SAME

(71) Applicant: CORNING INCORPORATED, Corning, NY (US)

(72) Inventors: LISA ANN LAMBERSON, PAINTED POST, NY (US); PETER JOSEPH LEZZI, CORNING, NY (US)

(21) Appl. No.: 18/224,780

(22) Filed: Jul. 21, 2023

Related U.S. Application Data
(60) Provisional application No. 63/527,367, filed on Jul. 18, 2023.

(51) Int. Cl. C03C 3/091

(52) U.S. Cl. CPC C03C 3/091; G02F 1/133302

(57) ABSTRACT

Aluminosilicate or aluminoborosilicate glass compositions and products comprising the same are provided. Such glass compositions are substantially alkali-free and include oxides of alkaline earth metals. The glass composition may include a low concentration of boron oxide. The glass compositions exhibit desirable physical properties and chemical properties, for example, improved annealing point (e.g., higher than 775° C.), improved elastic modulus, lowered stress optical coefficient (SOC), and desirable liquidus viscosity. The glass compositions are suitable for use as substrates in flat panel display devices such as active matrix liquid crystal displays (AMLCDs) with ultra-high resolution.

### PRIORITY CLAIM AND CROSS-REFERENCE

This application claims the benefit of priority under 35 U.S.C. § 119 of U.S. Provisional Application Ser. No. 63/527,367 filed on Jul. 18, 2023, the content of which is relied upon and incorporated herein by reference in its entirety.

### FIELD

The disclosure relates to glass compositions generally. More particularly, the disclosed subject matter relates to glass compositions suitable for use in display applications, articles comprising the glass compositions, and methods for making the same.

### BACKGROUND

Flat or curved substrates made of an optically transparent material such as glass are used for flat panel display, photovoltaic devices, and other suitable applications. In addition to the requirement for optical clarity, glass compositions need to meet different challenges depending on fabrication process and the applications.

For example, the production of liquid crystal displays such as active matrix liquid crystal display devices (AMLCDs) is complex, and the properties of the substrate glass are important. The glass substrates used in the production of AMLCD devices need to have their physical dimensions tightly controlled. The downdraw sheet drawing processes and, in particular, the fusion process, are capable of producing glass sheets that can be used as substrates without requiring costly post-forming finishing operations such as lapping and polishing. However, the fusion process places rather severe restrictions on the glass properties, which require relatively high liquidus viscosities.

In the liquid crystal display field, thin film transistors (TFTs) based on poly-crystalline silicon are preferably used because of their ability to transport electrons more effectively. Poly-crystalline based silicon transistors (p-Si) are characterized as having a higher mobility than those based on amorphous-silicon based transistors (a-Si). This allows the manufacture of smaller and faster transistors, which ultimately produces brighter and faster displays. One problem with p-Si based transistors is that their manufacture requires higher process temperatures than those employed in the manufacture of a-Si transistors. These temperatures range from 450° C. to 600° C. compared to the 350° C. peak temperatures employed in the manufacture of a-Si transistors.

The glass compositions used for display applications need to have good thermal and mechanical properties, and dimensional stability satisfying the processing and performance requirements. In addition, diffusion of meal ions into the thin film transistors may cause damages to the transistors. Such diffusion needs to be avoided.

The display technology such as TV moves toward 8K technology. 8K refers to the horizontal resolution in the order of 8,000 pixels. For example, when an 8K TV has a screen with 7,680 horizontal and 4,320 vertical pixels, such a TV may have a total of approximately 33 million pixels. 8K technology offers an ultra-high resolution. With four times more pixels than a 4K TV, which has an ultra-high definition (UHD) resolution, 8K TVs show a sharper and more detailed picture quality.

### SUMMARY

The present disclosure provides aluminosilicate or aluminoborosilicate glass compositions, products comprising the same, and methods of making the same. Such glass compositions are substantially alkali-free, and include oxides of alkaline earth metals. The glass composition may include a low concentration of boron oxide.

In one aspect, the present disclosure provides a glass or a glass composition. In accordance with some embodiments, a glass or a glass composition provided herein comprises in mole percent on an oxide basis:
SiO₂: 68.86-70.87;
Al₂O₃: 10.55-13.06;
B₂O₃: 0-2.29;
MgO: 4.82-6.4;
CaO: 5.31-7.35;
SrO: 0.3-3.74; and
BaO: 1.5-4.64.

Such a glass is an aluminosilicate glass or an aluminoborosilicate glass. The glass is substantially alkali-free defined by a combined concentration of Li₂O, Na₂O, and K₂O less than 0.1 mol. %, for example, less than 0.05 mol. %, less than 0.02%, less than 0.01%, or 0%.

In some embodiments, B₂O₃ is in a suitable range. For example, B₂O₃ is in a range of from 0.1 to 2.29 by mole percent, from 0.1 to 1.98 by mole percent, in a range of from 0.5 to 1.90 by mole percent, or in a range of from 0.5 to 1.60 by mole percent.

In some embodiments, a ratio of RO/Al₂O₃ is in a range of from 1.23 to 1.83 and RO is the sum of the mole percents of MgO, CaO, SrO, and BaO. For example, the ratio of RO/Al₂O₃ is in a range of from 1.39 to 1.83 in some embodiments. The ratio of RO/Al₂O₃ may also be in a range of from 1.09 to 1.83.

The glass may further comprise 0.01 mol. % to 0.4 mol. % of a chemical fining agent, which is selected from SnO₂, As₂O₃, Sb₂O₃, Fe₂O₃, CeO₂, MnO₂, F, Cl, Br, or any combination thereof. For example, the chemical fining agent comprises 0.08 mol. % to 0.13 mol. % of SnO₂ in some embodiments.

The glass has improved annealing point, for example, higher than 775° C. In some embodiments, the glass has an annealing point in a range from 775° C. to 810° C., for example, in a range from 780° C. to 810° C., or in a range from 785° C. to 810° C.

The glass also has improved elastic modulus (Young's modulus). For example, in some embodiments, the glass has an elastic modulus in a range of from 82.47 GPa to 84.90 GPa.

The glass has a desirable stress optical coefficient (SOC), which is relatively lower compared to those of existing products. For example, the glass provided in the present disclosure has a SOC in a range of from 27.70 to 29.70 in some embodiments.

In accordance with some embodiments, a glass provided in the present disclosure is an aluminoborosilicate glass, and comprises in mole percent on an oxide basis:
SiO₂: 68.86-70.87;
Al₂O₃: 10.55-13.06;
B₂O₃: 0.1-1.98;
MgO: 4.82-6.4;
CaO: 5.31-7.35;
SrO: 0.3-3.74; and
BaO: 1.5-4.64.

The glass is substantially alkali-free.

The glass has a ratio of RO/Al₂O₃ in a range of from 1.23 to 1.83, for example, from 1.39 to 1.83, and RO is the sum of the mole percents of MgO, CaO, SrO, and BaO.

The glass further comprises 0.08 mol. % to 0.13 mol. % of SnO₂ as a chemical fining agent. The glass has an annealing point in a range from 775° C. to 810° C., for example, in a range from 780° C. to 810° C., or in a range from 785° C. to 810° C.

The glass has an elastic modulus in a range of from 82.47 GPa to 84.90 GPa, and a stress optical coefficient (SOC) in a range of from 27.70 to 29.70.

In another aspect, the present disclosure provides an article comprising the glass or the glass composition described herein. For example, a substrate for liquid crystal display comprises the glass or the glass composition described here.

In another aspect, the present disclosure provides a device for flat panel display, which comprises at least one sheet comprising the glass as described herein. Such a device may further comprise polycrystalline silicon thin film transistors.

In another aspect, a method for producing the glass or the glass composition as described herein is provided. Such a method comprises at least one step of mixing and melting raw materials in mole percent on an oxide basis so as to provide the oxides as described. Such a method may further comprise making a sheet comprising the glass composition through a downdraw sheet fabrication process or a fusion process.

The glass compositions exhibit desirable physical properties and chemical properties, for example, improved annealing point (e.g., higher than 775° C.), improved elastic modulus, lowered stress optical coefficient (SOC), and desirable liquidus viscosity. The glass compositions are suitable for use as substrates in flat panel display devices such as active matrix liquid crystal displays (AMLCDs) with ultra-high resolution, for example, in the 8K display technology.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1 graphically depicts the relationship between the ratio of RO/Al₂O₃ and the stress optical coefficient (SOC) of exemplary inventive glass compositions in accordance with some embodiments.

FIG. 2 graphically depicts the relationship between the ratio of RO/Al₂O₃ and the elastic modulus of exemplary inventive glass compositions in accordance with some embodiments.

FIG. 3 graphically depicts the relationship between the stress optical coefficient (SOC) and the elastic modulus of the exemplary inventive glass compositions shown in FIGS. 1-2.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

Open terms such as “include,” “including,” “contain,” “containing” and the like mean “comprising.” These open-ended transitional phrases are used to introduce an open ended list of elements, method steps or the like that does not exclude additional, unrecited elements or method steps. It is understood that wherever embodiments are described with the language “comprising,” otherwise analogous embodiments described in terms of “consisting of” and/or “consisting essentially of” are also provided.

The transitional phrase “consisting of” and variations thereof excludes any element, step, or ingredient not recited, except for impurities ordinarily associated therewith.

The transitional phrase “consists essentially of,” or variations such as “consist essentially of” or “consisting essentially of” excludes any element, step, or ingredient not recited except for those that do not materially change the basic or novel properties of the specified method, structure or composition.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to +10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

The terms “substantial,” “substantially,” and variations thereof as used herein are intended to note that a described feature is equal or approximately equal to a value or description. Moreover, “substantially similar” is intended to denote that two values are equal or approximately equal. In some embodiments, “substantially similar” may denote values within about 10% of each other, such as within about 5% of each other, or within about 2% of each other.

The present disclosure provides aluminosilicate or aluminoborosilicate glass compositions, products such as articles or devices comprising the same, and method for making the glass composition and the products. Such glass compositions are substantially alkali-free, and include oxides of alkaline earth metals. The glass composition may include a low concentration of boron oxide. For example, the boron oxide is in a range of from 0 to 2.67 or from 0 to 2.29 by mole percent.

In some embodiments, the substrate is optically transparent. Examples of a substrate include, but are not limited to, a flat or curved glass panel.

Unless expressly indicated otherwise, the term “glass article” or “glass” used herein is understood to encompass any object made wholly or partly of glass. Glass articles include monolithic substrates, or laminates of glass and glass, glass and non-glass materials, glass and crystalline materials, and glass and glass-ceramics (which include an amorphous phase and a crystalline phase). Unless expressly indicated otherwise, the terms “glass” and “glass composition” used herein may be interchangeable.

The glass article such as a glass panel may be flat or curved, and is transparent or substantially transparent. As used herein, the term “transparent” is intended to denote that the article, at a thickness of approximately 1 mm, has a transmission of greater than about 85% in the visible region of the spectrum (400-700 nm). For instance, an exemplary transparent glass panel may have greater than about 85% transmittance in the visible light range, such as greater than about 90%, greater than about 95%, or greater than about 99% transmittance, including all ranges and subranges therebetween. According to various embodiments, the glass article may have a transmittance of less than about 50% in the visible region, such as less than about 45%, less than about 40%, less than about 35%, less than about 30%, less than about 25%, or less than about 20%, including all ranges and subranges therebetween. In certain embodiments, an exemplary glass panel may have a transmittance of greater than about 50% in the ultraviolet (UV) region (100-400 nm), such as greater than about 55%, greater than about 60%, greater than about 65%, greater than about 70%, greater than about 75%, greater than about 80%, greater than about 85%, greater than about 90%, greater than about 95%, or greater than about 99% transmittance, including all ranges and subranges therebetween.

Exemplary glasses can include, but are not limited to, aluminosilicate, and aluminoborosilicate. The glass article may be optionally strengthened. In some embodiments, the glass article may be strengthened mechanically by utilizing a mismatch of the coefficient of thermal expansion between portions of the article to create a compressive stress region and a central region exhibiting a tensile stress. In some embodiments, the glass article may be strengthened thermally by heating the glass to a temperature above the glass transition point and then rapidly quenching. In some other embodiments, the glass article may be chemically strengthening by ion exchange.

In the embodiments of the glass compositions described herein, the concentrations of constituent components (e.g., SiO₂, Al₂O₃, and the like) are specified in mole percent (mol. %) on an oxide basis, unless otherwise specified.

The terms “free” and “substantially free,” when used to describe the concentration and/or absence of a particular constituent component in a glass composition, means that the constituent component is not intentionally added to the glass composition. However, the glass composition may contain traces of the constituent component as a contaminant or tramp in amounts of less than 0.01 mol. %.

In some embodiments, the glass compositions provided herein are alkali-free or substantially alkali free. Unless expressly indicated otherwise, the term “alkali-free” or “substantially alkali-free” for a glass composition used herein is understood to encompass a glass composition having a combined concentration of Li₂O, Na₂O, and K₂O less than 0.1 mol. %, for example, less than 0.05 mol. %, less than 0.02 mol. %, less than 0.01 mol. %, or 0 mol %.

In the glass compositions described herein, the ratio of RO/Al₂O₃ is a ratio of a sum of the mole percents of RO to the mole percent of Al₂O₃, where RO includes MgO, CaO, SrO, BaO, and ZnO. When a composition does not comprise ZnO, RO refers to the mole percents of the oxides of alkaline earth metals, and the ratio of RO/Al₂O₃ is the same as the ration of (MgO+CaO+SrO+BaO)/Al₂O₃.

The term “softening point,” as used herein, refers to the temperature at which the viscosity of the glass composition is 1×10^{7.6} poise.

The term “annealing point,” as used herein, refers to the temperature at which the viscosity of the glass composition is 1×10¹³ poise.

The terms “strain point” and “Tₛₜᵣₐᵢₙ” as used herein, refers to the temperature at which the viscosity of the glass composition is 3×10¹⁴ poise.

The liquidus temperature of a glass (T_{liq}) is the temperature (C) above which no crystalline phases can coexist in equilibrium with the glass. The liquidus viscosity is the viscosity of a glass at the liquidus temperature.

The term “CTE,” as used herein, refers to the coefficient of thermal expansion of the glass composition over a temperature range from about room temperature (RT) to about 300° C. The linear coefficient of thermal expansion (CTE) over the temperature range 25-300° C. is expressed in terms of ×10⁻⁷/° C., and determined following ASTM standard E228.

Young's modulus values and shear modulus in terms of GPa, and Poisson's ratio were determined using a resonant ultrasonic spectroscopy technique of the general type set forth in ASTM E1875-00e1. The terms “Young's modulus” and “elastic modulus” may be interchangeable.

The fracture toughness may be measured using known methods in the art, for example, using a chevron notch, short bar, notched beam and the like, according to ASTM C1421-10, “Standard Test Methods for Determination of Fracture Toughness of Advanced Ceramics at Ambient Temperature.”

Stress optical coefficient (SOC) values can be measured as set forth in Procedure C (Glass Disc Method) of ASTM standard C770-16, entitled “Standard Test Method for Measurement of Glass Stress-Optical Coefficient.”

As the industry moves towards 8K display panels, thicker copper lines are needed to be used. Copper has a high CTE, and the thicker lines of copper will result in higher tensile film stress that will warp both the sheet and the panels. This could interfere with processing yield. Referring to Stoney's equation, shown below in Equation 1,

$$( R = \frac{{Et}^{3}}{6 ( 1 - v ) {σ}_{f} {t}_{f}} ) , \qquad ( Equation 1 )$$

R is the radius of curvature, E is the Young's modulus, t is the thickness of a cantilever, ν is Poisson's ratio, and σ is the surface stress generated.

It can be seen that the amount of strain is proportional to E (elastic modulus). Therefore, higher modulus (E) will result in lower strain/warp for a given stress.

In addition, panel makers are moving towards a borderless panel design, which results in excessive stress-induced light leakage (mura). Mura intensity is related to the glass stress optical coefficient (SOC) by Equation 2:

$$mura intensity ∝ {( SOC \times t )}^{2} , \qquad ( Equation 2 )$$

where t is thickness of glass sheet.

It is expected that deduction of the glass SOC will result in improvement in mura or less light leakage.

In the present disclosure, glasses were designed to increase physical properties such as Young's modulus, and decrease stress optical coefficient (SOC). In addition, glasses were designed to increase annealing point and obtain desirable liquidus temperature. An existing product, Corning Astra Glass, was chosen to be a benchmark for the developments described in the present disclosure.

Corning Astra Glass (abbreviated as “Astra” or “Astra Glass”) as an existing product, is a precisely engineered glass substrate enabling higher pixel density for the high-performance displays that panel-makers require to meet consumer demand for brighter, faster, and more lifelike images. Featuring an optimum blend of low total pitch variation (TPV), low total thickness variation (TTV), and low sag, Astra Glass is thermally and dimensionally stable enough to thrive in a broad range of processing temperatures, including oxide thin film transistor (TFT) backplane manufacturing processes.

In the present disclosure, the glasses were developed to increase their Young's modulus over that of Astra Glass (81.7 GPa) and decrease the SOC as compared to that of Astra Glass (30.0). The annealing point of these glasses were also designed to be greater than that of Astra Glass at 775° C., which is desirable as this improves the stress relaxation performance of the glass over that of Astra Glass, resulting in an improved TPV (total pitch variation). It was also desired to keep the 200P temperatures between that of Astra Glass (1,633° C.) and Corning Lotus NXT Glass (1,683° C.), and 35 kP temperature between that of Astra Glass (1,259° C.) and Lotus NXT (1,296° C.).

Table 1 shows exemplary ranges of ingredient contents and properties of the glasses designed, including the minimum and maximum of ingredient contents in exemplary glass compositions and their properties. As can be seen in Table 1, the Young's modulus for these glasses is ≥1% higher than that of Astra Glass and the SOC is ≥1% lower than that of Astra Glass. From the table it can also be seen that these glasses have ˜5-10° C. higher anneal point as compared to Astra Glass.

TABLE 1

| | MIN | MAX |
|---|---|---|
| mol % | | |
| SiO₂ | 68.86 | 70.87 |
| Al₂O₃ | 10.55 | 13.06 |
| B₂O₃ | 0.00 | 2.67 |
| MgO | 4.82 | 6.40 |
| CaO | 5.31 | 7.35 |
| SrO | 0.30 | 3.74 |
| BaO | 1.50 | 4.64 |
| SnO₂ | 0.08 | 0.13 |
| RO/Al₂O₃ | 1.09 | 1.83 |
| Physical Properties | | |
| Strain Point (fiber) ° C. | 721 | 756 |
| Annealing Point (fiber) ° C. | 773 | 808 |
| Softening Point (fiber) ° C. | 1001.7 | 1033.2 |
| CTE 0-300° C. (10⁻⁷) | 33.30 | 40.00 |
| Density (g/cc) | 2.530 | 2.650 |
| Young's Modulus (GPa) | 81.2 | 84.9 |
| Shear Modulus (GPa) | 33.6 | 34.1 |
| Poisson's ratio | 0.222 | 0.237 |
| SOC (nm/cm/MPa) | 27.7 | 29.7 |
| T(200 P) | 1612 | 1670 |
| T(35 kP) | 1251 | 1293 |
| Liquidus Viscosity (kP) | 69 | 276 |

In Table 1, B₂O₃ can be in a suitable range. For example, B₂O₃ is in a range of from 0.1 to 2.29 by mole percent, from 0.1 to 1.98 by mole percent, in a range of from 0.5 to 1.90 by mole percent, or in a range of from 0.5 to 1.60 by mole percent. The ratio of RO/Al₂O₃ may be in a range of from 1.23 to 1.83, and RO is the sum of the mole percents of MgO, CaO, SrO, BaO, and optional ZnO. For example, the ratio of RO/Al₂O₃ is in a range of from 1.39 to 1.83 in some embodiments. The ratio of RO/Al₂O₃ may also be in a range of from 1.09 to 1.83. In some embodiments, the SrO content is less than 1 mole percent. In Table 1, SnO₂ may be replaced by another suitable chemical fining agent as described herein.

In accordance with some embodiments, a glass or a glass composition provided herein comprises in mole percent on an oxide basis:
SiO₂: 68.86-70.87;
Al₂O₃: 10.55-13.06;
B₂O₃: 0-2.29;
MgO: 4.82-6.4;
CaO: 5.31-7.35;
SrO: 0.3-3.74; and
BaO: 1.5-4.64.

Such a glass is an aluminosilicate glass or an aluminoborosilicate glass. The glass is alkali-free or substantially alkali-free defined by a combined concentration of Li₂O, Na₂O, and K₂O less than 0.1 mol. %, for example, less than 0.05 mol. %, less than 0.02 mol. %, less than 0.01 mol. %, or 0%.

In some embodiments, B₂O₃ is in a suitable range. For example, B₂O₃ is in a range of from 0.1 to 2.29 by mole percent, from 0.1 to 1.98 by mole percent, in a range of from 0.5 to 1.90 by mole percent, or in a range of from 0.5 to 1.60 by mole percent.

In some embodiments, a ratio of RO/Al₂O₃ is in a range of from 1.23 to 1.83 and RO is the sum of the mole percents of MgO, CaO, SrO, and BaO. For example, the ratio of RO/Al₂O₃ is in a range of from 1.39 to 1.83 in some embodiments. The ratio of RO/Al₂O₃ may also be in a range of from 1.09 to 1.83.

The glass may further comprise 0.01 mol. % to 0.4 mol. % of a chemical fining agent, which is selected from SnO₂, As₂O₃, Sb₂O₃, Fe₂O₃, CeO₂, MnO₂, F, Cl, Br, or any combination thereof. For example, the chemical fining agent comprises 0.08 mol. % to 0.13 mol. % of SnO₂ in some embodiments.

The glass has improved annealing point, for example, higher than 775° C. In some embodiments, the glass has an annealing point in a range from 775° C. to 810° C., for example, in a range from 780° C. to 810° C., or in a range from 785° C. to 810° C.

The glass also has improved elastic modulus (Young's modulus). For example, in some embodiments, the glass has an elastic modulus in a range of from 82.47 GPa to 84.90 GPa.

The glass has a desirable stress optical coefficient (SOC), which is relatively lower compared to existing products. For example, the glass has a SOC in a range of from 27.70 to 29.70.

The glass has liquidus viscosity in a range of from 69,000 poise to 276,000 poise, for example, from 90,000 poise to 276,000 poise, from 100,000 poise to 276,000 poise, from 150,000 poise to 250,000 poise, or from 200,000 poise to 250,000 poise.

The glass also has other properties of suitable ranges, for example, those as shown in Table 1.

In accordance with some embodiments, a glass provided in the present disclosure is an aluminoborosilicate glass, and comprises in mole percent on an oxide basis:
SiO₂: 68.86-70.87;
Al₂O₃: 10.55-13.06;
B₂O₃: 0.1-1.98;
MgO: 4.82-6.4;
CaO: 5.31-7.35;
SrO: 0.3-3.74; and
BaO: 1.5-4.64.

The glass is substantially alkali-free defined by a combined concentration of Li₂O, Na₂O, and K₂O less than 0.1 mol. %.

The glass has a ratio of RO/Al₂O₃ in a range of from 1.23 to 1.83, for example, from 1.39 to 1.83, and RO is the sum of the mole percents of MgO, CaO, SrO, and BaO.

The glass further comprises 0.08 mol. % to 0.13 mol. % of SnO₂ as a chemical fining agent. The glass has an annealing point in a range from 775° C. to 810° C., for example, in a range from 780° C. to 810° C., or in a range from 785° C. to 810° C.

The glass has an elastic modulus in a range of from 82.47 GPa to 84.90 GPa, and a stress optical coefficient (SOC) in a range of from 27.70 to 29.70.

The glass has other desirable properties as described herein.

The inventors have surprisingly found that the compositions with specified oxide contents such as a low content of B₂O₃, particularly in combination with relatively high MgO content and a specified RO/Al₂O₃ ratio, provides glasses with suitably high values in higher annealing point, higher modulus, and lower stress optical coefficient (SOC), compared to the existing products such as Astra Glass. The compositions described herein provide a packed glass structure, which provides lower stress optical coefficient.

In the embodiments of the glass compositions described herein, SiO₂ is the largest constituent of the composition and, as such, is the primary constituent of the glass network. SiO₂ enhances the chemical durability of the glass and, in particular, the resistance of the glass composition to decomposition in acid, and provides a desirable liquiduis temperature or liquidus viscosity. The resulting chemical durability make the glass suitable for a flat panel display glass (e.g., an AMLCD glass). Accordingly, a high SiO₂ concentration is generally desired. However, if the content of SiO₂ is too high, the formability of the glass may be diminished as higher concentrations of SiO₂ increase the difficulty of melting the glass which, in turn, adversely impacts the formability of the glass.

In the embodiments described herein, the glass composition comprises SiO₂ in an amount greater than or equal to about 68.86 mol. % and less than or equal to about 70.87 mol. %. In some embodiments SiO₂ is present in the glass composition in an amount greater than or equal to about 69 mol. % and less than or equal to about 70.5 mol. %. In some other embodiments, SiO₂ is present in the glass composition in an amount greater than or equal to about 69 mol. % and less than or equal to about 70 mol. %.

The glass compositions described herein further include Al₂O₃. Al₂O₃ at a concentration equal to or greater than 10.55 mole percent provides the glass with a low liquidus temperature and high viscosity, resulting in a high liquidus viscosity. The use of at least 10.55 mole percent of Al₂O₃ also improves the glass's annealing point and modulus. Al₂O₃ improves the susceptibility of the glass to ion exchange strengthening. Moreover, additions of Al₂O₃ to the composition reduce the propensity of alkali constituents (such as Na and K), if there is any, from leaching out of the glass and, as such, additions of Al₂O₃ increase the resistance of the composition to hydrolytic degradation. Moreover, additions of Al₂O₃ may also increase the softening point of the glass thereby reducing the formability of the glass.

The glass compositions described herein include Al₂O₃ in an amount greater than or equal to about 10.55 mol. % and less than or equal to about 13.06 mol. %. In some embodiments, the amount of Al₂O₃ in the glass composition is greater than or equal to about 11 mol. % and less than or equal to about 13 mol. %. In some other embodiments, the amount of Al₂O₃ in the glass composition is greater than or equal to about 11 mol. % and less than or equal to about 12.5 mol. %.

In some embodiments, in order to have the ratio of RO/Al₂O₃ in a range of from 1.09 to 1.83, and RO is the sum of the mole percents of MgO, CaO, SrO, and BaO, when there is no ZnO added, the content of Al₂O₃ is kept below 13.06%. For example, the ratio of RO/Al₂O₃ is in a range of from 1.39 to 1.83 or in a range of from 1.23 to 1.83.

B₂O₃ is both a glass former and a flux that aids melting and lowers the melting temperature. It has an impact on both liquidus temperature and viscosity. Increasing B₂O₃ can be used to increase the liquidus viscosity of a glass. To achieve these effects, the glass compositions of one or more embodiments may have B₂O₃ concentrations that are equal to or greater than 0.1 mole percent. As discussed above with regard to SiO₂, glass durability is very important for LCD applications. Durability can be controlled somewhat by elevated concentrations of alkaline earth oxides, and significantly reduced by elevated B₂O₃ content. Annealing point decreases as B₂O₃ increases, so it may be helpful to keep B₂O₃ content low relative to its typical concentration in amorphous silicon substrates. Thus in some embodiments, the glass composition has B₂O₃ concentrations that are in the range of about 0.0 and 2.29 mole percent. It is surprisingly found that this low content of B₂O₃ increases elastic modulus of the resulting glass.

For example, B₂O₃ is in a range of from 0.1 to 2.29 by mole percent, from 0.1 to 1.98 by mole percent, in a range of from 0.5 to 1.90 by mole percent, or in a range of from 0.5 to 1.60 by mole percent. It was unexpectedly found that this lower level of B₂O₃ concentration, in combination with the ranges of other oxides, surprisingly provide the excellent properties of glass, for example, an annealing point higher than 775° C., improved modulus, and reduced stress optical coefficient. These properties make the glass suitable for the ultra-high resolution display applications such as in 8K display technology.

In addition to the glass formers (SiO₂, Al₂O₃, and B₂O₃), the glasses described herein also include alkaline earth oxides. In some embodiments, four alkaline earth oxides are present of the glass composition, e.g., MgO, CaO, BaO, and SrO. In another embodiment, SrO is substituted for BaO. The alkaline earth oxides provide the glass with various properties important to melting, fining, forming, and ultimate use. Accordingly, to improve glass performance in these regards, in one embodiment, the (MgO+CaO+SrO+BaO)/Al₂O₃ ratio is greater than or equal to 1.09. As this ratio increases, viscosity tends to decrease more strongly than liquidus temperature, and thus it is increasingly difficult to obtain suitably high values for liquidus viscosity. Thus in another embodiment, the ratio (MgO+CaO+SrO+BaO)/Al₂O₃ is less than or equal to 1.83.

A decrease in the RO concentration and an increase in the Al₂O₃ content is also a factor helping to provide a packed glass structure, which decreases the stress optical coefficient of the resulting glass.

For certain embodiments, the alkaline earth oxides may be treated as what is in effect a single compositional component. This is because their impact upon viscoelastic properties, liquidus temperatures and liquidus phase relationships are qualitatively more similar to one another than they are to the glass forming oxides SiO₂, Al₂O₃ and B₂O₃. However, the alkaline earth oxides CaO, SrO and BaO can form feldspar minerals, notably anorthite (CaAl₂Si₂O₈) and celsian (BaAl₂Si₂O₈) and strontium-bearing solid solutions of same, but MgO does not participate in these crystals to a significant degree. Therefore, when a feldspar crystal is already the liquidus phase, a superaddition of MgO may serves to stabilize the liquid relative to the crystal and thus lower the liquidus temperature. At the same time, the viscosity curve typically becomes steeper, reducing melting temperatures while having little or no impact on low-temperature viscosities. In this sense, the addition of small amounts of MgO benefits melting by reducing melting temperatures, benefits forming by reducing liquidus temperatures and increasing liquidus viscosity, while preserving high annealing point and, thus, low compaction. Thus, in various embodiments, the glass composition comprises MgO in an amount in the range of about 4.8 mole percent to about 6.4 mole percent.

In addition to MgO, the glass composition comprises CaO in a range of about 5.31 mole percent to about 7.35 mole percent, SrO of about 0.3 mole percent to about 3.74 mole percent, and BaO of about 1.5 mole percent to about 4.64 percent. These alkaline earth metal oxides in combination with other oxides including SiO₂, Al₂O₃ and B₂O₃ at specified mole percentages provide the excellent properties described herein.

Calcium oxide present in the glass composition can produce low liquidus temperatures (high liquidus viscosities), high annealing points and moduli, and CTE's in the most desired ranges for flat panel applications, specifically, AMLCD applications. It also contributes favorably to chemical durability, and compared to other alkaline earth oxides, it is relatively inexpensive as a batch material. However, at high concentrations, CaO increases the density and CTE. Furthermore, at sufficiently low SiO₂ concentrations, CaO may stabilize anorthite, thus decreasing liquidus viscosity. Accordingly, in one embodiment, the CaO concentration can be between 5.31 mole percent and 7.35 mole percent.

SrO and BaO can both contribute to low liquidus temperatures (high liquidus viscosities) and, thus, the glasses described herein will contain at least both of these oxides. However, the selection and concentration of these oxides are selected in order to avoid an increase in CTE and density and a decrease in modulus and annealing point. The relative proportions of SrO and BaO can be balanced so as to obtain a suitable combination of physical properties and liquidus viscosity such that the glass can be formed by a downdraw process. In some embodiments, the glass comprises SrO in range of about 0.3 mole percent to about 3.74 mole percent, and BaO in the range of about 1.5 mole percent to about 4.64 mole percent. In some embodiments, SrO is less than 1 mole percent.

In addition to meltability and annealing point considerations, for AMLCD applications, the CTE of the glass should be compatible with that of silicon. To achieve such CTE values, exemplary glasses control the RO content of the glass. For a given Al₂O₃ content, controlling the RO content corresponds to controlling the RO/Al₂O₃ ratio.

In one or more embodiments, the glasses provided in the present disclosure for use in AMLCD applications have coefficients of thermal expansion (CTEs) (22-300° C.) in the range of about 33.3×10⁻⁷/° C. to about 40.0×10⁻⁷/° C., or in the range of about 35×10⁻⁷/° C. to about 40×10⁻⁷/° C.

The glasses can be formable by a downdraw process, e.g., a fusion process, which means that the liquidus viscosity of the glass needs to be relatively high. Individual alkaline earths play an important role in this regard and they can destabilize the crystalline phases that would otherwise form. BaO and SrO are particularly effective in controlling the liquidus viscosity and are included in exemplary glasses for at least this purpose. As illustrated in the examples presented below, the combinations of the four alkaline earth oxides will produce glasses having high liquidus viscosities, with the total of the alkaline earths satisfying the RO/Al₂O₃ ratio constraints needed to achieve low melting temperatures, high annealing points, and suitable CTE's.

In addition to the above components, the glass compositions described herein can include various other oxides to adjust various physical, melting, fining, and forming attributes of the glasses. Examples of such other oxides include, but are not limited to, TiO₂, MnO, Fe₂O₃, ZnO, Nb₂O₅, MoO₃, ZrO₂, Ta₂O₅, WO₃, Y₂O₃, La₂O₃, and CeO₂. In some embodiments, these oxides are not added. In some embodiments, the amount of each of these oxides can be less than or equal to 0.5 mole percent such as less than 0.1 mole percent, and their total combined concentration can be less than or equal to 2.0 mole percent such as less than 1.0 mole percent.

The glass compositions described herein can also include various contaminants associated with batch materials and/or introduced into the glass by the melting, fining, and/or forming equipment used to produce the glass, particularly Fe₂O₃ and ZrO₂. The glasses can also contain SnO₂ either as a result of Joule melting using tin-oxide electrodes and/or through the batching of tin containing materials, e.g., SnO₂, SnO, SnCO₃, and SnC₂O₂.

As₂O₃ and Sb₂O₃ are effective high temperature fining agents for AMLCD glasses. However, special handling during the glass manufacturing process is needed because of their toxicity.

### Examples

The following examples are set forth below to illustrate the methods and results according to the disclosed subject matter. These examples are not intended to be inclusive of all embodiments of the subject matter disclosed herein, but rather to illustrate representative methods and results. These examples are not intended to exclude equivalents and variations of the present disclosure which are apparent to one skilled in the art.

Efforts have been made to ensure accuracy with respect to numbers (e.g., amounts, temperature, etc.) but some errors and deviations should be accounted for. Unless indicated otherwise, temperature is in ° C. or is at ambient temperature, and pressure is at or near atmospheric. The compositions themselves are given in mole percent on an oxide basis and have been normalized to 100%. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

The glass properties set forth in tables were determined in accordance with techniques conventional in the glass art. Thus, the linear coefficient of thermal expansion (CTE) over the temperature range 25-300° C. is expressed in terms of ×10⁻⁷/° C. and the annealing point is expressed in terms of ° C. These were determined from fiber elongation techniques (ASTM references E228-85 and C336, respectively). The density in terms of grams/cm³ was measured via the Archimedes method (ASTM C693). The melting temperature in terms of ° C. (defined as the temperature at which the glass melt demonstrates a viscosity of 200 poises) was calculated employing a Fulcher equation fit to high temperature viscosity data measured via rotating cylinders viscometry (ASTM C965-81).

The viscosity of the glass at high temperatures is measured in accordance with ASTM C965-96 (2012), titled “Standard Practice for Measuring Viscosity of Glass Above the Softening Point.” As used herein, the “Vogel-Fulcher-Tamman” (VFT) relation describes the temperature dependence of the viscosity and is represented by the following equation:

$$log η = A + B T - To$$

where η is viscosity. To determine VFT A, VFT B, and VFT Tₒ, the viscosity of the glass composition is measured over a given temperature range. The raw data of viscosity versus temperature is then fit with the VFT equation by least-squares fitting to obtain A, B, and Tₒ. With these values, a viscosity point (e.g., 200 Poise (P) Temperature, 35,000 P Temperature, and 200,000 P Temperature) at any temperature above softening point may be calculated.

The liquidus temperature of the glass in terms of ° C. was measured using the standard gradient boat liquidus method of ASTM C829-81. This involves placing crushed glass particles in a platinum boat, placing the boat in a furnace having a region of gradient temperatures, heating the boat in an appropriate temperature region for 24 hours, and determining by means of microscopic examination the highest temperature at which crystals appear in the interior of the glass. More particularly, the glass sample is removed from the Pt boat in one piece, and examined using polarized light microscopy to identify the location and nature of crystals which have formed against the Pt and air interfaces, and in the interior of the sample. Because the gradient of the furnace is very well known, temperature vs. location can be well estimated, within 5-10° C. The temperature at which crystals are observed in the internal portion of the sample is taken to represent the liquidus of the glass (for the corresponding test period). Testing is sometimes carried out at longer times (e.g. 72 hours), to observe slower growing phases. The liquidus viscosity in poises was determined from the liquidus temperature and the coefficients of the Fulcher equation.

Young's modulus values and shear modulus in terms of GPa, and Poisson's ratio were determined using a resonant ultrasonic spectroscopy technique of the general type set forth in ASTM E1875-00e1.

Stress optical coefficient (SOC) values can be measured as set forth in Procedure C (Glass Disc Method) of ASTM standard C770-16, entitled “Standard Test Method for Measurement of Glass Stress-Optical Coefficient.”

Exemplary glasses including Samples 1-71 are shown in Tables 2-12. As can be seen in Tables 2-12, the exemplary glasses have density, annealing point, Young's modulus, CLE, and stress optical coefficient (SOC) that make the glasses suitable for display applications, such as AMLCD substrate applications, and more particularly for low-temperature polysilicon and oxide thin film transistor applications. Although not shown in Tables 2-12, the glasses have durabilities in acid and base media that are similar to those obtained from commercial AMLCD substrates, and thus are appropriate for AMLCD applications. The exemplary glasses can be formed using downdraw techniques, and in particular are compatible with the fusion process, via the aforementioned criteria.

The exemplary glasses in the tables were prepared using a commercial sand as a silica source, milled such that 90% by weight passed through a standard U.S. 100 mesh sieve. Alumina was the alumina source, periclase was the source for MgO, limestone the source for CaO, strontium carbonate, strontium nitrate or a mix thereof was the source for SrO, barium carbonate was the source for BaO, and tin (IV) oxide was the source for SnO₂. The raw materials were thoroughly mixed, loaded into a platinum vessel suspended in a furnace heated by silicon carbide glowbars, melted and stirred for several hours at temperatures between 1600 and 1650° C. to ensure homogeneity, and delivered through an orifice at the base of the platinum vessel. The resulting patties of glass were annealed at or near the annealing point, and then subjected to various experimental methods to determine physical, viscous and liquidus attributes.

These methods are not unique, and the glasses of Tables 1-12 can be prepared using standard methods well-known to those skilled in the art. Such methods include a continuous melting process, such as would be performed in a continuous melting process, wherein the melter used in the continuous melting process is heated by gas, by electric power, or combinations thereof.

Raw materials appropriate for producing exemplary glasses include commercially available sands as sources for SiO₂; alumina, aluminum hydroxide, hydrated forms of alumina, and various aluminosilicates, nitrates and halides as sources for Al₂O₃; boric acid, anhydrous boric acid and boric oxide as sources for B₂O₃; periclase, dolomite (also a source of CaO), magnesia, magnesium carbonate, magnesium hydroxide, and various forms of magnesium silicates, aluminosilicates, nitrates and halides as sources for MgO; limestone, aragonite, dolomite (also a source of MgO), wolastonite, and various forms of calcium silicates, aluminosilicates, nitrates and halides as sources for CaO; and oxides, carbonates, nitrates and halides of strontium and barium. If a chemical fining agent is desired, tin can be added as SnO₂, as a mixed oxide with another major glass component (e.g., CaSnO₃), or in oxidizing conditions as SnO, tin oxalate, tin halide, or other compounds of tin known to those skilled in the art.

The glasses in Tables 2-12 contain SnO₂ as a fining agent, but other chemical fining agents could also be employed to obtain glass of sufficient quality for TFT substrate applications. For example, exemplary glasses could employ any one or combinations of As₂O₃, Sb₂O₃, CeO₂, Fe₂O₃, and halides as deliberate additions to facilitate fining, and any of these could be used in conjunction with the SnO₂ chemical fining agent shown in the examples. Of these, As₂O₃ and Sb₂O₃ are generally recognized as hazardous materials, subject to control in waste streams such as might be generated in the course of glass manufacture or in the processing of TFT panels. It is therefore desirable to limit the concentration of As₂O₃ and Sb₂O₃ individually or in combination to no more than 0.005 mol %.

In addition to the elements deliberately incorporated into exemplary glasses, nearly all stable elements in the periodic table are present in glasses at some level, either through low levels of contamination in the raw materials, through high-temperature erosion of refractories and precious metals in the manufacturing process, or through deliberate introduction at low levels to fine tune the attributes of the final glass. For example, zirconium may be introduced as a contaminant via interaction with zirconium-rich refractories. As a further example, platinum and rhodium may be introduced via interactions with precious metals. As a further example, iron may be introduced as a tramp in raw materials, or deliberately added to enhance control of gaseous inclusions. As a further example, manganese may be introduced to control color or to enhance control of gaseous inclusions.

As a further example, alkalis may be present as a tramp component at levels up to about 0.1 mol % for the combined concentration of Li₂O, Na₂O and K₂O.

Hydrogen is inevitably present in the form of the hydroxyl anion, OH, and its presence can be ascertained via standard infrared spectroscopy techniques. Dissolved hydroxyl ions significantly and nonlinearly impact the annealing point of exemplary glasses, and thus to obtain the desired annealing point it may be necessary to adjust the concentrations of major oxide components so as to compensate. Hydroxyl ion concentration can be controlled to some extent through choice of raw materials or choice of melting system. For example, boric acid is a major source of hydroxyls, and replacing boric acid with boric oxide can be a useful means to control hydroxyl concentration in the final glass. The same reasoning applies to other potential raw materials comprising hydroxyl ions, hydrates, or compounds comprising physisorbed or chemisorbed water molecules. If burners are used in the melting process, then hydroxyl ions can also be introduced through the combustion products from combustion of natural gas and related hydrocarbons, and thus it may be desirable to shift the energy used in melting from burners to electrodes to compensate. Alternatively, one might instead employ an iterative process of adjusting major oxide components so as to compensate for the deleterious impact of dissolved hydroxyl ions.

Sulfur is often present in natural gas, and likewise is a tramp component in many carbonate, nitrate, halide, and oxide raw materials. In the form of SO₂, sulfur can be a troublesome source of gaseous inclusions. The tendency to form SO₂-rich defects can be managed to a significant degree by controlling sulfur levels in the raw materials, and by incorporating low levels of comparatively reduced multivalent cations into the glass matrix. While not wishing to be bound by theory, it appears that SO₂-rich gaseous inclusions arise primarily through reduction of sulfate (SO₄⁻) dissolved in the glass.

The elevated barium concentrations of exemplary glasses appear to increase sulfur retention in the glass in early stages of melting, but as noted above, barium is required to obtain low liquidus temperature, and hence high T₃₅ₖ-T_{liq} and high liquidus viscosity. Deliberately controlling sulfur levels in raw materials to a low level is a useful means of reducing dissolved sulfur (presumably as sulfate) in the glass. In particular, sulfur is preferably less than 200 ppm by weight in the batch materials, and more preferably less than 100 ppm by weight in the batch materials.

Reduced multivalents can also be used to control the tendency of exemplary glasses to form SO₂ blisters. While not wishing to be bound to theory, these elements behave as potential electron donors that suppress the electromotive force for sulfate reduction. Sulfate reduction can be written in terms of a half reaction such as

SO₄⁻→SO₂+O₂+2e⁻

where e⁻ denotes an electron. The “equilibrium constant” for the half reaction is

$${K}_{eq} = {[ {SO}_{2} ] [ {O}_{2} ] [ {e}^{-} ]}^{2} / [ {SO}_{4}^{=} ]$$

where the brackets denote chemical activities. Ideally one would like to force the reaction so as to create sulfate from SO₂, O₂ and 2e⁻. Adding nitrates, peroxides, or other oxygen-rich raw materials may help, but also may work against sulfate reduction in the early stages of melting, which may counteract the benefits of adding them in the first place. SO₂ has very low solubility in most glasses, and so is impractical to add to the glass melting process. Electrons may be “added” through reduced multivalents. For example, an appropriate electron-donating half reaction for ferrous iron (Fe²⁺) is expressed as

2Fe²⁺→2Fe³⁺+2e⁻

This “activity” of electrons can force the sulfate reduction reaction to the left, stabilizing SO₄⁼ in the glass. Suitable reduced multivalents include, but are not limited to, Fe²⁺, Mn²⁺, Sn²⁺, Sb³⁺, As³⁺, V³⁺, Ti³⁺, and others familiar to those skilled in the art. In each case, it may be important to minimize the concentrations of such components so as to avoid deleterious impact on color of the glass, or in the case of As and Sb, to avoid adding such components at a high enough level so as to complication of waste management in an end-user's process.

In addition to the major oxides components of exemplary glasses, and the minor or tramp constituents noted above, halides may be present at various levels, either as contaminants introduced through the choice of raw materials, or as deliberate components used to eliminate gaseous inclusions in the glass. As a fining agent, halides may be incorporated at a level of about 0.4 mol % or less, though it is generally desirable to use lower amounts if possible to avoid corrosion of off-gas handling equipment. In some embodiments, the concentrations of individual halide elements are below about 200 ppm by weight for each individual halide, or below about 800 ppm by weight for the sum of all halide elements.

In addition to these major oxide components, minor and tramp components, multivalents and halide fining agents, it may be useful to incorporate low concentrations of other colorless oxide components to achieve desired physical, optical or viscoelastic properties. Such oxides include, but are not limited to, TiO₂, ZrO₂, HfO₂, Nb₂O₅, Ta₂O₅, MoO₃, WO₃, ZnO, In₂O₃, Ga₂O₃, Bi₂O₃, GeO₂, PbO, SeO₃, TeO₂, Y₂O₃, La₂O₃, Gd₂O₃, and others known to those skilled in the art. Through an iterative process of adjusting the relative proportions of the major oxide components of exemplary glasses, such colorless oxides can be added to a level of up to about 2 mol % without unacceptable impact to annealing point, T₃₅ₖ-T_{liq} or liquidus viscosity.

The samples and their data are summarized in Tables 2-12. In Tables 2-12, “EXG” represents one existing product Corning EAGLE XG® LCD glass substrate from Corning Incorporated (Corning, NY), and “Astra” represents another existing product Corning Astra Glass from Corning Incorporated as described above.

Table 2 shows examples of glasses (samples 1-8)

TABLE 2

| mol % | 1 | 2 | 3 | 4 | 5 | 6 | 7 | 8 |
|---|---|---|---|---|---|---|---|---|
| SiO₂ | 70.29 | 70.71 | 69.91 | 69.88 | 69.83 | 69.51 | 69.58 | 69.08 |
| Al₂O₃ | 12.83 | 12.08 | 12.34 | 12.79 | 11.92 | 11.85 | 11.65 | 11.64 |
| B₂O₃ | 2.01 | 0.00 | 1.96 | 2.63 | 1.45 | 1.93 | 1.87 | 1.91 |
| MgO | 4.82 | 6.13 | 5.53 | 4.91 | 5.97 | 5.93 | 5.48 | 5.46 |
| CaO | 5.69 | 6.26 | 5.78 | 5.50 | 6.17 | 6.14 | 6.86 | 7.35 |
| SrO | 1.63 | 0.30 | 1.81 | 2.49 | 0.30 | 0.30 | 0.81 | 0.81 |
| BaO | 2.61 | 4.30 | 2.52 | 1.69 | 4.20 | 4.16 | 3.55 | 3.54 |
| SnO₂ | 0.09 | 0.12 | 0.12 | 0.10 | 0.11 | 0.13 | 0.13 | 0.13 |
| Fe₂O₃ | 0.01 | 0.00 | 0.01 | 0.01 | 0.01 | 0.01 | 0.01 | 0.01 |
| ZrO₂ | 0.02 | 0.00 | 0.01 | 0.01 | 0.03 | 0.03 | 0.00 | 0.00 |
| Na₂O | 0.00 | 0.10 | 0.00 | 0.00 | 0.00 | 0.00 | 0.04 | 0.04 |
| K₂O | 0.00 | 0.00 | 0.00 | 0.00 | 0.00 | 0.00 | 0.00 | 0.00 |
| TiO₂ | 0.00 | 0.00 | 0.00 | 0.00 | 0.00 | 0.00 | 0.03 | 0.03 |
| RO/Al₂O₃ | 1.15 | 1.41 | 1.27 | 1.14 | 1.4 | 1.39 | 1.43 | 1.47 |
| Physical Properties | 1 | 2 | 3 | 4 | 5 | 6 | 7 | 8 |
| Strain Point | 743 | 756 | 732 | 731 | 730 | 723 | 725 | 721 |
| (fiber) ° C. | | | | | | | | |
| Annealing Point | 796 | 808 | 785 | 785 | 782 | 776 | 778 | 773 |
| (fiber) ° C. | | | | | | | | |
| Strain Point (BBV) | 743 | 757 | 735.8 | 730.8 | 730.7 | 725.1 | 726.3 | 719.7 |
| ° C. | | | | | | | | |
| Annealing Point | 794 | 807 | 785.5 | 781.7 | 780.9 | 776.8 | 776.5 | 771 |
| (BBV) ° C. | | | | | | | | |
| Softening Point | 1031.4 | — | 1022.2 | 1023.7 | 1019.3 | 1014.3 | 1013.1 | 1007.7 |
| (fiber) ° C. | | | | | | | | |
| CTE 0-300° C. (10⁻⁷) | 35.9 | 37.5 | 37.6 | 35.5 | 38.2 | 39.1 | 37.7 | 38.3 |
| Density (g/cc) | 2.58 | 2.63 | 2.58 | 2.552 | 2.617 | 2.612 | 2.601 | 2.603 |
| Young's Modulus | 83.5 | 84.9 | 82.8 | 83.0 | 83.2 | 82.6 | 82.6 | 82.6 |
| (GPa) | | | | | | | | |
| Shear Modulus (GPa) | 33.8 | — | 33.8 | 33.7 | 33.9 | 33.7 | 33.6 | 33.6 |
| Poisson's ratio | 0.237 | — | 0.227 | 0.230 | 0.226 | 0.226 | 0.229 | 0.228 |
| SOC (nm/cm/MPa) | 29.1 | 27.8 | 29.3 | 28.8 | 28.5 | 28.4 | 28.7 | 28.5 |
| High Temperature | 1 | 2 | 3 | 4 | 5 | 6 | 7 | 8 |
| Viscosity | | | | | | | | |
| A | −3.13 | −3.13 | −3.17 | −3.16 | −3.16 | −3.17 | −3.18 | −3.22 |
| B | 7002.6 | 6976.2 | 7005.1 | 7007.4 | 7015.5 | 7029.9 | 7029.1 | 7019.6 |
| To | 375.1 | 383.5 | 369.4 | 369.4 | 366.8 | 361.0 | 360.4 | 358.8 |
| T(200P) | 1665 | 1668 | 1650 | 1652 | 1651 | 1645 | 1642 | 1629 |
| T(35kP) | 1288 | 1293 | 1277 | 1278 | 1277 | 1272 | 1270 | 1262 |
| Isothermal hold | 1 | 2 | 3 | 4 | 5 | 6 | 7 | 8 |
| results | | | | | | | | |
| 1180° C. crystallinity | — | — | — | — | — | — | — | — |
| 1180° C. phase(s) | — | — | — | — | — | — | — | — |
| 1180° C. secondary | — | — | — | — | — | — | — | — |
| phase(s) | | | | | | | | |
| 1190° C. crystallinity | — | — | — | — | — | — | — | — |
| 1190° C. phase(s) | — | — | — | — | — | — | — | — |
| 1190° C. secondary | — | — | — | — | — | — | — | — |
| phase(s) | | | | | | | | |
| 1200° C. crystallinity | — | — | 2% Pt/ | 3% Pt/ | 1% Pt/ | 0% Pt/ | trace % Pt/ | 0% Pt/ |
| | | | trace zirc | trace zirc | 0% zirc | 0% zirc | 0% zirc | 0% zirc |
| 1200° C. phase(s) | — | — | Cordierite | Cordierite | Cordierite | — | Anorthite | Anorthite |
| | | | or Celsian | | | | | |
| 1200 secondary | — | — | — | — | Cristobalite | — | — | Cristobalite |
| phase(s) | | | | | | | | |
| 1210° C. crystallinity | — | — | trace % Pt/ | 1% Pt/ | trace % Pt/ | 0% Pt/ | 0% Pt/ | 0% Pt/ |
| | | | 0% zirc | 0% zirc | 0% zirc | 0% zirc | 0% zirc | 0% zirc |
| 1210° C. phase(s) | — | — | Anorthite | Cordierite | Cordierite | — | — | — |
| 1210° C. secondary | — | — | — | — | — | — | — | — |
| phase(s) | | | | | | | | |
| Liquidus viscosity | 1 | 2 | 3 | 4 | 5 | 6 | 7 | 8 |
| Lowest isothermal | — | — | 1190 | 1190 | 1185 | 1180 | 1180 | 1180 |
| pass (pass is <2% | | | | | | | | |
| internal crystals) | | | | | | | | |
| Liquidus viscosity | — | — | 232 | 237 | 257 | 256 | 247 | 211 |
| (kP) | | | | | | | | |

Table 3 shows examples of glasses (samples 9-17)

TABLE 3

| mol % | 9 | 10 | 11 | 12 | 13 | 14 | 15 | 16 | 17 |
|---|---|---|---|---|---|---|---|---|---|
| SiO₂ | 69.12 | 70.01 | 69.8 | 69.14 | 69.84 | 69.75 | 69.85 | 69.72 | 69.6 |
| Al₂O₃ | 11.61 | 10.61 | 11.47 | 11.07 | 12.42 | 12.45 | 12.43 | 12.4 | 12.03 |
| B₂O₃ | 1.90 | 1.01 | 0.99 | 0.99 | 2.28 | 2.33 | 2.32 | 2.36 | 1.88 |
| MgO | 5.95 | 5.99 | 6.15 | 6.40 | 5.40 | 5.39 | 5.40 | 5.43 | 5.69 |
| CaO | 6.87 | 7.08 | 6.44 | 6.71 | 5.77 | 5.77 | 5.77 | 5.82 | 6.15 |
| SrO | 0.81 | 1.12 | 0.56 | 0.82 | 1.76 | 1.77 | 1.78 | 1.81 | 1.52 |
| BaO | 3.53 | 3.97 | 4.37 | 4.64 | 2.38 | 2.39 | 2.29 | 2.3 | 2.97 |
| SnO₂ | 0.13 | 0.13 | 0.13 | 0.13 | 0.08 | 0.09 | 0.09 | 0.09 | 0.10 |
| Fe₂O₃ | 0.01 | 0.01 | 0.01 | 0.01 | 0.01 | 0.01 | 0.01 | 0.01 | 0.01 |
| ZrO₂ | 0.00 | 0.00 | 0.00 | 0.00 | 0.00 | 0.00 | 0.00 | 0.00 | 0.00 |
| Na₂O | 0.03 | 0.03 | 0.04 | 0.05 | 0.03 | 0.03 | 0.03 | 0.03 | 0.02 |
| K₂O | 0.00 | 0.00 | 0.00 | 0.00 | 0.01 | 0.01 | 0.01 | 0.01 | 0.01 |
| TiO₂ | 0.03 | 0.04 | 0.04 | 0.04 | 0.02 | 0.02 | 0.02 | 0.02 | 0.03 |
| RO/Al₂O₃ | 1.48 | 1.71 | 1.53 | 1.68 | 1.23 | 1.23 | 1.23 | 1.24 | 1.36 |
| Physical Properties | 9 | 10 | 11 | 12 | 13 | 14 | 15 | 16 | 17 |
| Strain Point (fiber) ° C. | 721 | 724 | 732 | 725 | 728 | 734 | 731 | 729 | 728 |
| Annealing Point | 774 | 776 | 784 | 776 | 782 | 787 | 784 | 782 | 782 |
| (fiber) ° C. | | | | | | | | | |
| Strain Point (BBV) ° C. | 721.3 | 725.9 | 731.6 | 724.7 | 731.3 | 732.3 | 730.2 | 730.8 | — |
| Annealing Point (BBV) | 772.3 | 774.9 | 782.3 | 775.1 | 783.4 | 784 | 782.3 | 781.5 | — |
| ° C. | | | | | | | | | |
| Softening Point (fiber) | 1008.3 | 1009.2 | 1020.1 | 1008.6 | 1020.6 | 1020.5 | 1021.7 | 1019.9 | 1018 |
| ° C. | | | | | | | | | |
| CTE 0-300° C. (10⁻⁷) | 38.3 | 39.2 | 38.4 | 39.9 | 37.2 | 37.1 | 37.1 | 37.2 | 36.4 |
| Density (g/cc) | 2.606 | 2.632 | 2.635 | 2.65 | 2.568 | 2.568 | 2.564 | 2.566 | 2.591 |
| Young's Modulus (GPa) | 82.7 | 82.7 | 83.1 | 83.0 | 82.7 | 82.7 | 82.7 | 82.7 | 83.0 |
| Shear Modulus (GPa) | 33.6 | 33.7 | 33.8 | 33.8 | 33.6 | 33.7 | 33.6 | 33.6 | 33.8 |
| Poisson's ratio | 0.228 | 0.227 | 0.230 | 0.228 | 0.229 | 0.228 | 0.229 | 0.229 | 0.227 |
| SOC (nm/cm/MPa) | 28.6 | 28.0 | 28.1 | 27.7 | 29.4 | 29.3 | 29.3 | 29.2 | 28.6 |
| High Temperature | 9 | 10 | 11 | 12 | 13 | 14 | 15 | 16 | 17 |
| Viscosity | | | | | | | | | |
| A | −3.22 | −3.17 | −3.17 | −3.22 | −3.17 | −3.18 | −3.17 | −3.18 | −3.19 |
| B | 7019.3 | 7048.2 | 7018.5 | 7024.7 | 7010.7 | 7010.1 | 7010.7 | 7010.7 | 7011.0 |
| To | 358.8 | 356.0 | 365.0 | 357.9 | 367.6 | 367.3 | 367.6 | 366.6 | 365.1 |
| T(200P) | 1629 | 1645 | 1648 | 1631 | 1649 | 1647 | 1649 | 1646 | 1642 |
| T(35kP) | 1262 | 1270 | 1275 | 1263 | 1276 | 1275 | 1276 | 1274 | 1272 |
| Isothermal hold results | 9 | 10 | 11 | 12 | 13 | 14 | 15 | 16 | 17 |
| 1180° C. crystallinity | — | — | — | — | — | — | — | — | 3% Pt/>50% |
| | | | | | | | | | zirc |
| 1180° C. phase(s) | — | — | — | — | — | — | — | — | Anorthite |
| 1180° C. secondary | — | — | — | — | — | — | — | — | Cristobalite |
| phase(s) | | | | | | | | | |
| 1190° C. crystallinity | — | — | — | — | — | — | — | — | 2% Pt/>5% |
| | | | | | | | | | zirc |
| 1190° C. phase(s) | — | — | — | — | — | — | — | — | Anorthite |
| 1190° C. secondary | — | — | — | — | — | — | — | — | Cristobalite |
| phase(s) | | | | | | | | | |
| 1200° C. crystallinity | 0% Pt/ | 0% Pt/ | 0% Pt/ | 0% Pt/ | 1% Pt/ | 2% Pt/ | 2% Pt/ | 1% Pt/ | trace % Pt/ |
| | 0% zirc | 0% zirc | 0% zirc | 0% zirc | 2% zirc | 1% zirc | >50% zirc | 0% zirc | 0% zirc |
| 1200° C. phase(s) | Anorthite | Cristobalite | Cristobalite | | Cordierite | Cordierite | Cristobalite | Cordierite | Anorthite |
| 1200 secondary phase(s) | — | — | — | — | Cristobalite | — | — | Cristobalite | — |
| 1210° C. crystallinity | 0% Pt/ | 0% Pt/ | 0% Pt/ | 0% Pt/ | trace % Pt/ | 1% Pt/ | 1% Pt/ | trace % Pt/ | 0% Pt/ |
| | 0% zirc | 0% zirc | 0% zirc | 0% zirc | 0% zirc | 0% zirc | trace % zirc | 0% zirc | 0% zirc |
| 1210° C. phase(s) | — | — | — | — | Cristobalite | Cordierite | Cordierite | Cristobalite | Anorthite |
| 1210° C. secondary | — | — | — | — | — | — | — | — | — |
| phase(s) | | | | | | | | | |
| Liquidus viscosity | 9 | 10 | 11 | 12 | 13 | 14 | 15 | 16 | 17 |
| Lowest isothermal pass | 1180 | 1180 | 1180 | 1180 | 1190 | 1190 | 1190 | 1185 | 1190 |
| (pass is <2% internal | | | | | | | | | |
| crystals) | | | | | | | | | |
| Liquidus viscosity (kP) | 210 | 243 | 276 | 213 | 226 | 221 | 226 | 243 | 203 |

Table 4 shows examples of glasses (samples 18-25)

TABLE 4

| mol % | 18 | 19 | 20 | 21 | 22 | 23 | 24 | 25 |
|---|---|---|---|---|---|---|---|---|
| SiO₂ | 69.45 | 69.39 | 68.86 | 68.93 | 69.37 | 69.61 | 70.87 | 69.96 |
| Al₂O₃ | 12.46 | 12.24 | 11.56 | 10.55 | 10.55 | 12.46 | 12.73 | 13.02 |
| B₂O₃ | 2.46 | 2.23 | 1.89 | 0.99 | 1.00 | 2.45 | 2.44 | 2.23 |
| MgO | 5.45 | 5.44 | 5.92 | 6.16 | 5.96 | 5.34 | 5.23 | 5.48 |
| CaO | 6.13 | 6.50 | 6.89 | 7.30 | 7.09 | 5.74 | 5.45 | 5.31 |
| SrO | 1.34 | 1.19 | 2.09 | 3.15 | 3.68 | 1.87 | 1.66 | 1.91 |
| BaO | 2.51 | 2.80 | 2.60 | 2.73 | 2.18 | 2.37 | 1.50 | 1.95 |
| SnO₂ | 0.11 | 0.13 | 0.13 | 0.12 | 0.12 | 0.09 | 0.1 | 0.1 |
| Fe₂O₃ | 0.01 | 0.01 | 0.01 | 0.01 | 0.01 | 0.01 | 0.01 | 0.01 |
| ZrO₂ | 0.00 | 0.00 | 0.00 | 0.00 | 0.00 | 0.00 | 0.00 | 0.00 |
| Na₂O | 0.02 | 0.02 | 0.02 | 0.02 | 0.02 | 0.03 | 0.01 | 0.02 |
| K₂O | 0.01 | 0.01 | 0.01 | 0.01 | 0.01 | 0.01 | 0.00 | 0.00 |
| TiO₂ | 0.02 | 0.03 | 0.02 | 0.03 | 0.02 | 0.02 | 0.00 | 0.00 |
| RO/Al₂O₃ | 1.24 | 1.3 | 1.51 | 1.83 | 1.79 | 1.23 | 1.09 | 1.13 |
| Physical | 18 | 19 | 20 | 21 | 22 | 23 | 24 | 25 |
| Properties | | | | | | | | |
| Strain Point | 730 | 726 | 722 | 721 | 723 | 728 | 735 | 739 |
| (fiber) ° C. | | | | | | | | |
| Annealing | 783 | 780 | 774 | 773 | 773 | 781 | 790 | 792 |
| Point | | | | | | | | |
| (fiber) ° C. | | | | | | | | |
| Strain Point | — | — | — | — | — | 727.8 | — | — |
| (BBV) ° C. | | | | | | | | |
| Annealing | — | — | — | — | — | 779.8 | — | — |
| Point | | | | | | | | |
| (BBV) ° C. | | | | | | | | |
| Softening | 1019.5 | 1017 | 1004.2 | 1004.8 | 1001.7 | 1018.3 | 1033.2 | 1030 |
| Point | | | | | | | | |
| (fiber) ° C. | | | | | | | | |
| CTE 0-300° C. | 35.4 | 36.1 | 38.4 | 39.5 | 40.0 | 37.6 | 33.3 | 33.8 |
| (10⁻⁷) | | | | | | | | |
| Density | 2.567 | 2.579 | 2.605 | 2.632 | 2.611 | 2.57 | 2.525 | 2.556 |
| (g/cc) | | | | | | | | |
| Young's | 82.8 | 82.8 | 83.4 | 83.7 | 83.6 | 82.5 | 83.0 | 83.6 |
| Modulus | | | | | | | | |
| (GPa) | | | | | | | | |
| Shear | 33.6 | 33.7 | 34.0 | — | — | 33.6 | 33.9 | 34.1 |
| Modulus | | | | | | | | |
| (GPa) | | | | | | | | |
| Poisson's | 0.230 | 0.228 | 0.228 | — | — | 0.228 | 0.226 | 0.228 |
| ratio | | | | | | | | |
| SOC | 29.0 | 29.0 | 28.3 | 28.0 | 28.0 | 29.0 | 29.7 | 29.3 |
| (nm/cm/MPa) | | | | | | | | |
| High | 18 | 19 | 20 | 21 | 22 | 23 | 24 | 25 |
| Temperature | | | | | | | | |
| Viscosity | | | | | | | | |
| A | −3.2 | −3.2 | −3.26 | −3.27 | −3.25 | −3.18 | −3.11 | −3.17 |
| B | 7007.2 | 7008.6 | 7007.4 | 7018.8 | 7022.5 | 7012.7 | 7009.9 | 6983.9 |
| To | 365.8 | 364.7 | 358.3 | 353.5 | 355.1 | 365.8 | 374.7 | 376.1 |
| T(200P) | 1641 | 1638 | 1618 | 1612 | 1620 | 1645 | 1670 | 1652 |
| T(35kP) | 1271 | 1270 | 1256 | 1251 | 1256 | 1274 | 1290 | 1281 |
| Isothermal | 18 | 19 | 20 | 21 | 22 | 23 | 24 | 25 |
| hold results | | | | | | | | |
| 1180° C. | 5% Pt | 2% Pt/ | 3% Pt/ | 5% Pt/ | 25% Pt/ | — | — | — |
| crystallinity | >50% zirc | 20% zirc | >50% zirc | >50% zirc | >50% zirc | | | |
| 1180° C. | Cristobalite | Anorthite | Anorthite | Cristobalite | Anorthite | — | — | — |
| phase(s) | | | | | | | | |
| 1180° C. | Cordierite, | Cordierite | — | Anorthite, | Cristobalite, | — | — | — |
| secondary | Anorthite | | | Cordierite | Cordierite | | | |
| phase(s) | | | | | | | | |
| 1190° C. | 3% Pt/ | 1% Pt/ | 2% Pt/ | 3% Pt/ | 15% Pt/ | — | — | — |
| crystallinity | >50% zirc | trace % zirc | 20% zirc | >50% zirc | >50% zirc | | | |
| 1190° C. | Cristobalite | Anorthite | Anorthite | Cristobalite | Anorthite | — | — | — |
| phase(s) | | | | | | | | |
| 1190° C. | Cordierite, | Cordierite | | Anorthite, | Cristobalite, | | | |
| secondary | Anorthite | | | Cordierite | Cordierite | | | |
| phase(s) | | | | | | | | |
| 1200° C. | 1% Pt/ | trace % Pt/ | trace % Pt/ | trace % Pt/ | 3% Pt/ | 3% Pt/ | — | — |
| crystallinity | 0% zirc | t0% zirc | 0% zirc | 0% zirc | >30% zirc | trace % zirc | | |
| 1200° C. | Anorthite | Anorthite | Anorthite | Anorthite | Anorthite | Cordierite | — | — |
| phase(s) | | | | | | | | |
| 1200° C. | Cordierite | — | — | — | Cristobalite, | — | — | — |
| secondary | | | | | Cordierite | | | |
| phase(s) | | | | | | | | |
| 1210° C. | trace % Pt/ | 0% Pt/ | 0% Pt/ | 0% Pt/ | 1% Pt/ | 0% Pt/ | — | — |
| crystallinity | 0% zirc | 0% zirc | 0% zirc | 0% zirc | trace % zirc | 0% zirc | | |
| 1210° C. | Anorthite | Anorthite | Anorthite | Anorthite | Anorthite | Cordierite | — | — |
| phase(s) | | | | | | | | |
| 1210° C. | Cordierite | — | — | — | Cristobalite, | — | — | — |
| secondary | | | | | Cordierite | | | |
| phase(s) | | | | | | | | |
| Liquidus | 18 | 19 | 20 | 21 | 22 | 23 | 24 | 25 |
| viscosity | | | | | | | | |
| Lowest | 1195 | 1190 | 1185 | 1195 | 1205 | 1205 | 1240 | 1220 |
| isothermal | | | | | | | | |
| pass (pass | | | | | | | | |
| is <2% | | | | | | | | |
| internal | | | | | | | | |
| crystals) | | | | | | | | |
| Liquidus | 180 | 195 | 164 | 116 | 103 | 150 | 97 | 127 |
| viscosity | | | | | | | | |
| (kP) | | | | | | | | |

Table 5 shows examples of glasses (samples 26-32)

TABLE 5

| mol % | 26 | 27 | 28 | 29 | 30 | 31 | 32 |
|---|---|---|---|---|---|---|---|
| SiO₂ | 70.01 | 69.63 | 69.77 | 69.82 | 69.21 | 69.57 | 69.20 |
| Al₂O₃ | 13.06 | 12.85 | 11.44 | 11.45 | 11.69 | 11.14 | 12.29 |
| B₂O₃ | 2.56 | 2.67 | 0.99 | 0.96 | 1.29 | 1.20 | 2.22 |
| MgO | 5.31 | 5.47 | 6.21 | 6.21 | 5.20 | 5.65 | 6.13 |
| CaO | 5.69 | 5.55 | 6.50 | 6.48 | 6.85 | 6.95 | 6.50 |
| SrO | 1.47 | 1.56 | 1.58 | 2.08 | 3.74 | 3.41 | 0.97 |
| BaO | 1.76 | 2.13 | 3.29 | 2.79 | 1.82 | 1.89 | 2.52 |
| SnO₂ | 0.10 | 0.10 | 0.13 | 0.13 | 0.13 | 0.13 | 0.10 |
| Fe₂O₃ | 0.01 | 0.01 | 0.01 | 0.01 | 0.01 | 0.01 | 0.01 |
| ZrO₂ | 0.00 | 0.00 | 0.01 | 0.01 | 0.01 | 0.01 | 0.01 |
| Na₂O | 0.01 | 0.02 | 0.03 | 0.02 | 0.01 | 0.01 | 0.02 |
| K₂O | 0.00 | 0.00 | 0.01 | 0.01 | 0.01 | 0.01 | 0.01 |
| TiO₂ | 0.00 | 0.00 | 0.03 | 0.03 | 0.02 | 0.02 | 0.02 |
| RO/Al₂O₃ | 1.09 | 1.14 | 1.54 | 1.53 | 1.51 | 1.61 | 1.31 |
| Physical | 26 | 27 | 28 | 29 | 30 | 31 | 32 |
| Properties | | | | | | | |
| Strain Point | 735 | 730 | 734 | 734 | 730 | 728 | 725 |
| (fiber) ° C. | | | | | | | |
| Annealing | 789 | 783 | 786 | 786 | 782 | 780 | 778 |
| Point (fiber) | | | | | | | |
| ° C. | | | | | | | |
| Strain Point | — | — | — | — | — | — | — |
| (BBV) ° C. | | | | | | | |
| Annealing | — | — | — | — | — | — | — |
| Point (BBV) | | | | | | | |
| ° C. | | | | | | | |
| Softening | 1028.2 | 1022.9 | 1018.8 | 1019 | 1013.1 | 1009.4 | 1012.7 |
| Point (fiber) | | | | | | | |
| ° C. | | | | | | | |
| CTE 0-300° C. | 35.1 | 35.1 | — | — | — | — | — |
| (10⁻⁷) | | | | | | | |
| Density | 2.538 | 2.552 | 2.621 | 2.614 | 2.613 | 2.611 | 2.565 |
| (g/cc) | | | | | | | |
| Young's | 83.1 | 82.5 | 83.4 | 83.6 | 83.8 | 83.7 | 82.6 |
| Modulus | | | | | | | |
| (GPa) | | | | | | | |
| Shear | 33.9 | 33.8 | 34.0 | 34.1 | 233.7 | 233.7 | 33.6 |
| Modulus | | | | | | | |
| (GPa) | | | | | | | |
| Poisson's | 0.227 | 0.222 | 0.228 | 0.228 | 0.230 | 0.230 | 0.229 |
| ratio | | | | | | | |
| SOC | 29.5 | 29.4 | 28.2 | 28.2 | 28.2 | 28.3 | 29.0 |
| (nm/cm/MPa) | | | | | | | |
| High | 26 | 27 | 28 | 29 | 30 | 31 | 32 |
| Temperature | | | | | | | |
| Viscosity | | | | | | | |
| A | −3.17 | −3.18 | −3.2 | −3.21 | −3.24 | −3.23 | −3.24 |
| B | 6988.1 | 6999.5 | 7005.2 | 6998.6 | 6990.6 | 7008.3 | 6988.8 |
| To | 374.8 | 369.5 | 366.1 | 367.3 | 365.4 | 361.4 | 366.3 |
| T(200P) | 1652 | 1645 | 1640 | 1638 | 1626 | 1628 | 1627 |
| T(35kP) | 1281 | 1275 | 1271 | 1270 | 1263 | 1263 | 1264 |
| Isothermal | 26 | 27 | 28 | 29 | 30 | 31 | 32 |
| hold results | | | | | | | |
| 1180° C. | — | — | — | — | — | — | 5% air/3% int/20% pt/>50 zirc |
| crystallinity | | | | | | | |
| 1180° C. | — | — | — | — | — | — | cordierite |
| phase(s) | | | | | | | |
| 1180° C. | — | — | — | — | — | — | cristobalite |
| secondary | | | | | | | |
| phase(s) | | | | | | | |
| 1190° C. | — | — | 5% air/ 3% | 10% | >50 air/>50 | >50 air/>50 | 5% air/3% int/20% pt/>50 zirc |
| crystallinity | | | internal/3% | air/10% | int/>50 | int/>50 | |
| | | | pt/5% zirc | int./40% | pt/>50 | pt/>50 | |
| | | | | pt/>50 | zirc | zirc | |
| | | | | zirc | slawsonite | calcium | |
| 1190° C. | — | — | calcium | calcium | | solid | cordierite |
| phase(s) | | | solid | solid | | solution | |
| | | | solution | solution | | | |
| 1190° C. | — | — | — | — | — | — | cristobalite |
| secondary | | | | | | | |
| phase(s) | | | | | | | |
| 1200° C. | — | — | trace air/0 | 2% | >50 | 15 air/10 | 2% air/trace int/2% pt/trace |
| crystallinity | | | int/0 pt/0 | air/1% | air/30 | int/10 | zirc |
| | | | zirc | int/1% | int/>50 | pt/30 | |
| | | | | pt/5% | pt/> 50 | zirc | |
| | | | | zirc | zirc | calcium | |
| 1200° C. | — | — | calcium | calcium | slawsonite | solid | cordierite |
| phase(s) | | | solid | solid | | solution | |
| | | | solution | solution | | | |
| 1200 | — | — | — | — | — | — | cristobalite |
| secondary | | | | | | | |
| phase(s) | | | | | | | |
| 1210° C. | — | — | 0% air/0% int/0% | 1% air/ | >50 air/20 | 7 air/5 | trace air/0 int/trace pt/0 zirc |
| crystallinity | | | pt/0% zirc | 0% int/0% | int/40 | int/5 | |
| | | | | pt/0% zirc | pt/30 zirc | pt/5 | |
| | | | | | slawsonite | zirc | |
| 1210° C. | — | — | — | calcium | | calcium | cordierite |
| phase(s) | | | | solid | | solid | |
| | | | | solution | | solution | |
| 1210° C. | — | — | — | — | — | — | — |
| secondary | | | | | | | |
| phase(s) | | | | | | | |
| Liquidus | 26 | 27 | 28 | 29 | 30 | 31 | 32 |
| viscosity | | | | | | | |
| Lowest | 1235 | 1210 | 1195 | 1195 | 1230 | 1215 | 1200 |
| isothermal | | | | | | | |
| pass (pass is <2% | | | | | | | |
| internal | | | | | | | |
| crystals) | | | | | | | |
| Liquidus | 90 | 139 | 179 | 178 | 69 | 95 | 139 |
| viscosity (kP) | | | | | | | |

Table 6 shows examples of glasses (samples 33-37).

TABLE 6

| mol % | 33 | 34 | 35 | 36 | 37 |
|---|---|---|---|---|---|
| SiO₂ | 69.87 | 69.31 | 69.26 | 69.79 | 69.66 |
| Al₂O₃ | 11.49 | 11.12 | 12.11 | 11.58 | 12.26 |
| B₂O₃ | 1.08 | 1.04 | 2.09 | 1.26 | 2.18 |
| MgO | 6.10 | 6.33 | 6.15 | 6.10 | 5.61 |
| CaO | 6.40 | 6.70 | 6.52 | 6.43 | 5.95 |
| SrO | 0.82 | 0.91 | 1.01 | 1.99 | 1.85 |
| BaO | 3.93 | 4.27 | 2.60 | 2.57 | 2.23 |
| SnO₂ | 0.12 | 0.12 | 0.12 | 0.12 | 0.10 |
| Fe₂O₃ | 0.00 | 0.00 | 0.00 | 0.00 | 0.00 |
| ZrO₂ | 0.10 | 0.10 | 0.10 | 0.09 | 0.09 |
| Na₂O | 0.06 | 0.06 | 0.03 | 0.03 | 0.02 |
| K₂O | 0.02 | 0.01 | 0.01 | 0.01 | 0.01 |
| TiO₂ | 0.00 | 0.03 | 0.00 | 0.02 | 0.01 |
| RO/Al₂O₃ | 1.5 | 1.64 | 1.34 | 1.48 | 1.28 |
| Physical | 33 | 34 | 35 | 36 | 37 |
| Properties | | | | | |
| Strain Point | 739 | 734 | 737 | 742 | 739 |
| (fiber) ° C. | | | | | |
| Annealing Point | 791 | 785 | 788 | 794 | 791 |
| (fiber) ° C. | | | | | |
| Strain Point | — | — | — | — | — |
| (BBV) ° C. | | | | | |
| Annealing Point | — | — | — | — | — |
| (BBV) ° C. | | | | | |
| Softening Point | 1020.5 | 1013.8 | 1016.1 | 1020.1 | 1024.5 |
| (fiber) ° C. | | | | | |
| CTE 0-300° C. | 38.2 | 39.7 | 35.8 | 37.5 | 35.6 |
| (10⁻⁷) | | | | | |
| Density (g/cc) | 2.627 | 2.649 | 2.58 | 2.604 | 2.575 |
| Young's Modulus | 83.7 | 83.6 | 83.6 | 83.9 | 83.4 |
| (GPa) | | | | | |
| Shear Modulus | 34.1 | 34.0 | 34.1 | 34.1 | 34.0 |
| (GPa) | | | | | |
| Poisson's ratio | 0.228 | 0.231 | 0.227 | 0.230 | 0.227 |
| SOC | 28.3 | 27.8 | 28.9 | 28.5 | 29.1 |
| (nm/cm/MPa) | | | | | |
| High | 33 | 34 | 35 | 36 | 37 |
| Temperature | | | | | |
| Viscosity | | | | | |
| A | −3.17 | −3.2 | −3.23 | −3.2 | −3.19 |
| B | 7019.49 | 7024.99 | 6996.18 | 7002.94 | 7008.1 |
| To | 365.36 | 359.25 | 365.28 | 366.63 | 366.6 |
| T(200 P) | 1649 | 1635 | 1630 | 1640 | 1644 |
| T(35 kP) | 1276 | 1266 | 1265 | 1271 | 1273 |
| Isothermal hold | 33 | 34 | 35 | 36 | 37 |
| results | | | | | |
| 1180° C. | 3% air/5% int/ | 5% air/5% int/ | 40% air/30% | >50 air/25% | 30% air/25% |
| crystallinity | 15% pt/>50% zirc | 10% pt/>50% zirc | int/>50% pt/>50 | int/>50 pt/>50 | int/>50% pt/>50 |
| 1180° C. phase(s) | Cristobalite | Cristobalite | Cristobalite | Cristobalite | Cristobalite |
| 1180° C. | Cordierite | Calcium solid | Cordierite and | Cordierite and | Cordierite and |
| secondary | | solution | calcium solid | calcium solid | calcium solid |
| phase(s) | | feldspar | solution | solution | solution |
| | | | feldspar | feldspar | feldspar |
| 1190° C. | 3% air/3% int/ | 1% air/1% int/ | 5% air/2% int/ | 3% air/3% int/ | —/1% int/1% |
| crystallinity | 10% pt/>50% zirc | 1% pt/0% zirc | 2% pt/>50 | 10% pt/>50 | pt/trace |
| 1190° C. phase(s) | Cristobalite | Calcium solid | Cristobalite | Cristobalite | Cordierite |
| | | solution | | | |
| | | feldspar | | | |
| 1190° C. | Cordierite | scum | Cordierite and | Cordierite and | scum |
| secondary | | | calcium solid | calcium solid | |
| phase(s) | | | solution | solution | |
| | | | feldspar | feldspar | |
| 1200° C. | trace/0% int/ | 0% air/0% int/ | 2% air/1% int/ | trace/0/0/0 | 1% air/trace/ |
| crystallinity | 0% pt/0% zirc | 0% pt/0% zirc | 1% pt/>50 | | trace/trace |
| 1200° C. phase(s) | Cordierite | — | Cordierite | Cordierite | Cordierite |
| 1200 secondary | — | — | Cristobalite | — | — |
| phase(s) | | | | | |
| 1210° C. | — | — | — | — | — |
| crystallinity | | | | | |
| 1210° C. phase(s) | — | — | — | — | — |
| 1210° C. | — | — | — | — | — |
| secondary | | | | | |
| phase(s) | | | | | |
| Liquidus | 33 | 34 | 35 | 36 | 37 |
| viscosity | | | | | |
| Lowest | 1195 | 1185 | 1190 | 1195 | 1190 |
| isothermal pass | | | | | |
| (pass is <2% | | | | | |
| internal crystals) | | | | | |
| Liquidus | 197 | 201 | 179 | 179 | 211 |
| viscosity (kP) | | | | | |

Table 7 shows examples of glasses (samples 38-44)

TABLE 7

| mol % | 38 | 39 | 40 | 41 | 42 | 43 | 44 |
|---|---|---|---|---|---|---|---|
| SiO₂ | 69.60 | 69.02 | 69.08 | 69.22 | 69.28 | 69.34 | 69.47 |
| Al₂O₃ | 12.49 | 11.77 | 11.84 | 11.91 | 12.00 | 12.08 | 12.17 |
| B₂O₃ | 2.52 | 1.97 | 1.99 | 2.06 | 2.11 | 2.19 | 2.19 |
| MgO | 5.39 | 5.80 | 5.76 | 5.69 | 5.67 | 5.61 | 5.56 |
| CaO | 6.05 | 6.71 | 6.61 | 6.49 | 6.38 | 6.27 | 6.16 |
| SrO | 1.38 | 2.05 | 2.03 | 2.00 | 1.96 | 1.94 | 1.91 |
| BaO | 2.34 | 2.51 | 2.50 | 2.46 | 2.43 | 2.40 | 2.38 |
| SnO₂ | 0.10 | 0.11 | 0.11 | 0.11 | 0.11 | 0.11 | 0.11 |
| Fe₂O₃ | 0.00 | 0.01 | 0.01 | 0.01 | 0.01 | 0.01 | 0.01 |
| ZrO₂ | 0.09 | 0.00 | 0.00 | 0.00 | 0.00 | 0.00 | 0.00 |
| Na₂O | 0.02 | 0.02 | 0.02 | 0.02 | 0.02 | 0.01 | 0.01 |
| K₂O | 0.01 | 0.01 | 0.01 | 0.01 | 0.01 | 0.01 | 0.01 |
| TiO₂ | 0.01 | 0.02 | 0.02 | 0.02 | 0.02 | 0.02 | 0.02 |
| RO/Al₂O₃ | 1.21 | 1.45 | 1.43 | 1.4 | 1.37 | 1.34 | 1.32 |
| Physical | 38 | 39 | 40 | 41 | 42 | 43 | 44 |
| Properties | | | | | | | |
| Strain Point | 738 | 726 | 727 | 725 | 729 | 726 | 728 |
| (fiber) ° C. | | | | | | | |
| Annealing | 791 | 777 | 779 | 777 | 781 | 779 | 781 |
| Point (fiber) | | | | | | | |
| ° C. | | | | | | | |
| Strain Point | — | — | — | — | — | — | — |
| (BBV) ° C. | | | | | | | |
| Annealing | — | — | — | — | — | — | — |
| Point (BBV) ° C. | | | | | | | |
| Softening | 1024.5 | 1007 | 1011.6 | 1011 | 1012 | 1011.8 | 1016.7 |
| Point (fiber) | | | | | | | |
| ° C. | | | | | | | |
| CTE 0-300 | 35.4 | 37.5 | 37.6 | 37.2 | 37.0 | 36.3 | 35.8 |
| ° C. (10⁻⁷) | | | | | | | |
| Density | 2.563 | 2.594 | 2.593 | 2.588 | 2.585 | 2.581 | 2.577 |
| (g/cc) | | | | | | | |
| Young's | 83.0 | 83.0 | 83.0 | 82.9 | 82.8 | 82.9 | 82.6 |
| Modulus | | | | | | | |
| (GPa) | | | | | | | |
| Shear | 33.8 | 33.9 | 33.8 | 33.8 | 33.7 | 33.7 | 33.6 |
| Modulus | | | | | | | |
| (GPa) | | | | | | | |
| Poisson's | 0.229 | 0.227 | 0.230 | 0.228 | 0.229 | 0.230 | 0.227 |
| ratio | | | | | | | |
| SOC | 29.5 | 28.6 | 28.5 | 28.6 | 28.7 | 28.8 | 28.9 |
| (nm/cm/MPa) | | | | | | | |
| High | 38 | 39 | 40 | 41 | 42 | 43 | 44 |
| Temperature | | | | | | | |
| Viscosity | | | | | | | |
| A | −3.18 | −3.25 | −3.24 | −3.23 | −3.22 | −3.22 | −3.2 |
| B | 7010.1 | 7004.8 | 7005.2 | 7007.3 | 7006.9 | 7008.3 | 7007.5 |
| To | 366.3 | 360.6 | 361.4 | 362.0 | 362.8 | 363.2 | 364.6 |
| T(200P) | 1645 | 1623 | 1626 | 1629 | 1631 | 1634 | 1637 |
| T(35kP) | 1274 | 1260 | 1261 | 1264 | 1265 | 1266 | 1269 |
| Isothermal | 38 | 39 | 40 | 41 | 42 | 43 | 44 |
| hold results | | | | | | | |
| 1180° C. | 15% air/20 | 5% air/3% | 7% air/5 | 5% air/3% | 7% air/5% | 7% air/5% | 5% air/3% |
| crystallinity | % int/40% | int/2% pt/>50 | % int/10% | int/5% pt/>50 | int/5% pt/>50 | int/5% pt/>50 | int/3% pt/>50 |
| | pt/>50 | | pt/>50 | | | | |
| 1180° C. | Cristobalite | Calcium | Calcium | Calcium | Calcium | Calcium | Calcium |
| phase(s) | | solid | solid | Solid | solid | solid | solid |
| | | solution | solution | solution | solution | solution | solution |
| | | feldspar | feldspar | feldspar | feldspar | feldspar | feldspar |
| 1180° C. | Cordierite | Cristobalite | Cristobalite | Cristobalite | Cristobalite | Cristobalite | Cristobalite |
| secondary | and | | | | | | |
| phase(s) | calcium | | | | | | |
| | solid | | | | | | |
| | solution | | | | | | |
| | feldspar | | | | | | |
| 1190° C. | 2% air/5% | 2% air/1% | 2% air/2% | 3% air/2% | 5% air/3% | 3% air/2% | 2% air/1% |
| crystallinity | int/1% pt/>50 | internal/ | int/2% pt/ | int/3% pt/25 | int/3% pt/ | int/2% pt/1 | pt/1% pt/1 |
| | | 1% pt/Trace | trace | | trace | | |
| 1190° C. | Cristobalite | Calcium | Calcium | Calcium | Calcium | Calcium | Calcium |
| phase(s) | | solid | solid | Solid | solid | solid | solid |
| | | solution | solution | solution | solution | solution | solution |
| | | feldspar | feldspar | feldspar | feldspar | feldspar | feldspar |
| 1190° C. | Cordierite | — | — | — | — | — | — |
| secondary | | | | | | | |
| phase(s) | | | | | | | |
| 1200° C. | 2% air/2% | trace/ | 1% air/ | 1% air/1% | 1% air/ | 2% air/ | 1% air/ |
| crystallinity | int/1% pt/ | trace/ | trace/ | int/1% pt/ | trace/ | trace/1% | trace/ |
| | trace | trace/0 | trace/0 | trace | trace/0 | pt/0 | trace/0 |
| 1200° C. | Cordierite | Calcium | Calcium | Calcium | Calcium | Calcium | Calcium |
| phase(s) | | solid | solid | solid | solid | solid | solid |
| | | solution | solution | solution | solution | solution | solution |
| | | feldspar | feldspar | feldspar | feldspar | feldspar | feldspar |
| 1200 | Cristobalite | — | — | — | — | — | — |
| secondary | | | | | | | |
| phase(s) | | | | | | | |
| 1210° C. | — | — | — | — | — | — | — |
| crystallinity | | | | | | | |
| 1210° C. | — | — | — | — | — | — | — |
| phase(s) | | | | | | | |
| 1210° C. | — | — | — | — | — | — | — |
| secondary | | | | | | | |
| phase(s) | | | | | | | |
| Liquidus | 38 | 39 | 40 | 41 | 42 | 43 | 44 |
| viscosity | | | | | | | |
| Lowest | 1195 | 1185 | 1190 | 1190 | 1195 | 1190 | 1185 |
| isothermal | | | | | | | |
| pass (pass is <2% | | | | | | | |
| internal | | | | | | | |
| crystals) | | | | | | | |
| Liquidus | 189 | 177 | 164 | 171 | 157 | 183 | 217 |
| viscosity (kP) | | | | | | | |

Table 8 shows examples of glasses (samples 45-48)

TABLE 8

| mol % | 45 | 46 | 47 | 48 |
|---|---|---|---|---|
| SiO₂ | 68.73 | 68.93 | 69.14 | 69.20 |
| Al₂O₃ | 12.63 | 12.39 | 12.23 | 12.17 |
| B₂O₃ | 4.03 | 3.13 | 2.33 | 2.17 |
| MgO | 4.96 | 5.51 | 5.99 | 6.06 |
| CaO | 5.39 | 6.02 | 6.42 | 6.54 |
| SrO | 3.23 | 2.08 | 1.24 | 1.07 |
| BaO | 0.85 | 1.74 | 2.42 | 2.56 |
| SnO₂ | 0.11 | 0.11 | 0.11 | 0.11 |
| Fe₂O₃ | 0.01 | 0.01 | 0.01 | 0.01 |
| ZrO₂ | 0.02 | 0.02 | 0.03 | 0.02 |
| Na₂O | 0.02 | 0.04 | 0.05 | 0.06 |
| K₂O | 0.00 | 0.00 | 0.00 | 0.00 |
| TiO₂ | 0.01 | 0.02 | 0.02 | 0.02 |
| RO/Al₂O₃ | 1.14 | 1.24 | 1.31 | 1.33 |
| Physical Properties | 45 | 46 | 47 | 48 |
| Strain Point (fiber) | 727 | 732 | 733 | 733 |
| ° C. | | | | |
| Annealing Point | 779 | 784 | 785 | 785 |
| (fiber) ° C. | | | | |
| Strain Point (BBV) | — | — | — | 725 |
| ° C. | | | | |
| Annealing Point | — | — | — | 774.9 |
| (BBV) ° C. | | | | |
| Softening Point | — | 1007.3 | — | 1009.5 |
| (fiber) ° C. | | | | |
| CTE 0-300° C. | 34.3 | 35.3 | 35.9 | 36.1 |
| (10⁻⁷) | | | | |
| Density (g/cc) | 2.524 | 2.546 | 2.566 | 2.568 |
| Young's Modulus | 81.7 | 82.6 | 83.4 | 83.4 |
| (GPa) | | | | |
| Shear Modulus | — | — | — | — |
| (GPa) | | | | |
| Poisson's ratio | — | — | — | — |
| SOC (nm/cm/MPa) | 30.0 | 29.4 | 28.9 | 28.9 |
| High Temperature | 45 | 46 | 47 | 48 |
| Viscosity | | | | |
| A | −3.232 | −3.237 | −3.238 | −3.238 |
| B | 7040.3 | 7020.8 | 7002.5 | 7000.1 |
| To | 353.1 | 358.5 | 364.0 | 364.8 |
| T(200 P) | 1626 | 1626 | 1628 | 1629 |
| T(35 kP) | 1258 | 1261 | 1264 | 1264 |
| Isothermal hold | 45 | 46 | 47 | 48 |
| results | | | | |
| 1180° C. | — | — | — | 15% Pt/yes zirc |
| crystallinity | | | | |
| 1180° C. phase(s) | — | — | — | Cristobalite |
| 1180° C. secondary | — | — | — | Cordeirite + |
| phase(s) | | | | Anorthite |
| 1190° C. | — | — | — | 10% Pt/yes zirc |
| crystallinity | | | | |
| 1190° C. phase(s) | — | — | — | Cristobalite |
| 1190° C. secondary | — | — | — | Cordeirite + |
| phase(s) | | | | Anorthite |
| 1200° C. | — | — | — | 1% Pt/no zirc |
| crystallinity | | | | |
| 1200° C. phase(s) | — | — | — | Cordeirite |
| 1200 secondary | — | — | — | — |
| phase(s) | | | | |
| 1210° C. | — | — | — | 0% Pt/no zirc |
| crystallinity | | | | |
| 1210° C. phase(s) | — | — | — | — |
| 1210° C. secondary | — | — | — | — |
| phase(s) | | | | |
| Liquidus viscosity | 45 | 46 | 47 | 48 |
| Lowest isothermal | — | — | — | 1200 |
| pass (pass is <2% | | | | |
| internal crystals) | | | | |
| Liquidus viscosity | — | — | — | 139 |
| (kP) | | | | |

In Table 8, Samples 45 and 46 can be considered as a comparative samples in the present disclosure even though they show excellent performance. Sample 48 is a good experimental sample in accordance with some embodiments. Samples 46-47 show a gradual transition from Sample 45 to Sample 48.

Table 9 shows examples of glasses (samples 49-54)

TABLE 9

| mol % | 49 | 50 | 51 | 52 | 53 | 54 |
|---|---|---|---|---|---|---|
| SiO₂ | 69.32 | 69.17 | 69.20 | 69.25 | 69.21 | 69.20 |
| Al₂O₃ | 11.91 | 11.77 | 11.68 | 11.57 | 11.50 | 11.49 |
| B₂O₃ | 1.87 | 1.64 | 1.63 | 1.47 | 1.40 | 1.40 |
| MgO | 6.08 | 6.17 | 6.23 | 6.18 | 6.25 | 6.27 |
| CaO | 6.57 | 6.66 | 6.64 | 6.70 | 6.71 | 6.71 |
| SrO | 1.01 | 0.96 | 0.95 | 0.93 | 0.93 | 0.92 |
| BaO | 3.00 | 3.39 | 3.43 | 3.66 | 3.77 | 3.78 |
| SnO₂ | 0.11 | 0.11 | 0.10 | 0.11 | 0.11 | 0.10 |
| Fe₂O₃ | 0.01 | 0.01 | 0.01 | 0.01 | 0.01 | 0.01 |
| ZrO₂ | 0.03 | 0.02 | 0.02 | 0.03 | 0.02 | 0.02 |
| Na₂O | 0.06 | 0.06 | 0.07 | 0.07 | 0.07 | 0.07 |
| K₂O | 0.00 | 0.01 | 0.01 | 0.01 | 0.01 | 0.01 |
| TiO₂ | 0.03 | 0.03 | 0.03 | 0.03 | 0.03 | 0.03 |
| RO/Al₂O₃ | 1.40 | 1.46 | 1.48 | 1.51 | 1.54 | 1.54 |
| Physical Properties | 49 | 50 | 51 | 52 | 53 | 54 |
| Strain Point (fiber) ° C. | 733 | 732 | 732 | 732 | 732 | 731 |
| Annealing Point (fiber) | 784 | 783 | 784 | 783 | 783 | 783 |
| ° C. | | | | | | |
| Strain Point (BBV) ° C. | — | — | 721.9 | — | — | 723.3 |
| Annealing Point | — | — | 772.6 | — | — | 773 |
| (BBV) ° C. | | | | | | |
| Softening Point (fiber) | — | — | 1008 | — | 1006.5 | 1006.5 |
| ° C. | | | | | | |
| CTE 0-300° C. (10⁻⁷) | 37.0 | 37.9 | 38.0 | 38.5 | 38.7 | 38.8 |
| Density (g/cc) | | | 2.604 | 2.614 | 2.619 | 2.619 |
| Young's Modulus | 83.5 | 83.6 | 83.5 | 83.5 | 83.6 | 83.2 |
| (GPa) | | | | | | |
| Shear Modulus (GPa) | — | — | — | — | — | — |
| Poisson's ratio | — | — | — | — | — | — |
| SOC (nm/cm/MPa) | 28.6 | 28.3 | 28.5 | 28.2 | 28.1 | 28.1 |
| High Temperature | 49 | 50 | 51 | 52 | 53 | 54 |
| Viscosity | | | | | | |
| A | −3.224 | −3.232 | −3.230 | −3.223 | −3.226 | −3.227 |
| B | 7008.8 | 7008.7 | 7012.5 | 7015.9 | 7016.4 | 7016.5 |
| To | 363.7 | 362.9 | 361.9 | 361.0 | 361.1 | 360.9 |
| T(200P) | 1632 | 1630 | 1630 | 1632 | 1630 | 1630 |
| T(35kP) | 1266 | 1264 | 1264 | 1265 | 1264 | 1264 |
| Isothermal hold results | 49 | 50 | 51 | 52 | 53 | 54 |
| 1180° C. crystallinity | — | — | 3% Pt/yes zirc | — | — | 1% Pt/yes zirc |
| 1180° C. phase(s) | — | — | Anorthite | — | — | Anorthite |
| 1180° C. secondary | — | — | — | — | — | — |
| phase(s) | | | | | | |
| 1190° C. crystallinity | — | — | trace % Pt/no zirc | — | — | 0% Pt/yes zirc |
| 1190° C. phase(s) | — | — | Anorthite | — | — | Anorthite |
| 1190° C. secondary | — | — | — | — | — | — |
| phase(s) | | | | | | |
| 1200° C. crystallinity | — | — | 0% Pt/no zirc | — | — | 0% Pt/no zirc |
| 1200° C. phase(s) | — | — | | — | — | |
| 1200 secondary | — | — | — | — | — | — |
| phase(s) | | | | | | |
| 1210° C. crystallinity | — | — | 0% Pt/no zirc | — | — | 0% Pt/no zirc |
| 1210° C. phase(s) | — | — | — | — | — | — |
| 1210° C. secondary | — | — | — | — | — | — |
| phase(s) | | | | | | |
| Liquidus viscosity | 49 | 50 | 51 | 52 | 53 | 54 |
| Lowest isothermal pass | — | — | 1190 | — | — | 1180 |
| (pass is <2% internal | | | | | | |
| crystals) | | | | | | |
| Liquidus viscosity (kP) | — | — | 173 | — | — | 218 |

Table 10 shows examples of glasses (samples 55-60)

TABLE 10

| mol % | 55 | 56 | 57 | 58 | 59 | 60 |
|---|---|---|---|---|---|---|
| SiO₂ | 69.14 | 69.18 | 69.30 | 69.23 | 69.54 | 69.93 |
| Al₂O₃ | 11.48 | 11.21 | 11.17 | 11.26 | 11.78 | 12.30 |
| B₂O₃ | 1.41 | 1.14 | 1.00 | 1.11 | 1.52 | 2.14 |
| MgO | 6.27 | 6.34 | 6.33 | 6.31 | 5.90 | 5.45 |
| CaO | 6.73 | 6.78 | 6.76 | 6.73 | 6.48 | 6.13 |
| SrO | 0.92 | 0.89 | 0.89 | 0.92 | 1.11 | 1.32 |
| BaO | 3.81 | 4.21 | 4.30 | 4.18 | 3.44 | 2.53 |
| SnO₂ | 0.10 | 0.11 | 0.12 | 0.11 | 0.11 | 0.10 |
| Fe₂O₃ | 0.01 | 0.01 | 0.01 | 0.01 | 0.01 | 0.01 |
| ZrO₂ | 0.02 | 0.02 | 0.02 | 0.02 | 0.02 | 0.02 |
| Na₂O | 0.07 | 0.07 | 0.07 | 0.07 | 0.06 | 0.04 |
| K₂O | 0.01 | 0.01 | 0.01 | 0.01 | 0.01 | 0.00 |
| TiO₂ | 0.03 | 0.03 | 0.03 | 0.03 | 0.03 | 0.02 |
| RO/Al₂O₃ | 1.54 | 1.63 | 1.64 | 1.61 | 1.44 | 1.25 |
| Physical Properties | 55 | 56 | 57 | 58 | 59 | 60 |
| Strain Point (fiber) ° C. | 731 | 732 | 732 | 735 | 737 | 737 |
| Annealing Point (fiber) | 782 | 783 | 783 | 787 | 790 | 790 |
| ° C. | | | | | | |
| Strain Point (BBV) ° C. | — | — | — | — | — | — |
| Annealing Point (BBV) | — | — | — | — | — | — |
| ° C. | | | | | | |
| Softening Point (fiber) | — | — | 1004.4 | — | — | — |
| ° C. | | | | | | |
| CTE 0-300° C. (10⁻⁷) | 38.9 | 39.8 | 39.9 | 39.6 | 37.8 | 35.4 |
| Density (g/cc) | 2.619 | 2.640 | 2.640 | | 2.603 | 2.562 |
| Young's Modulus (GPa) | 83.5 | 83.5 | 82.6 | 83.6 | 83.5 | 83.1 |
| Shear Modulus (GPa) | — | — | — | — | — | — |
| Poisson's ratio | — | — | — | — | — | — |
| SOC (nm/cm/MPa) | 28.1 | 27.8 | 27.7 | 27.9 | 28.4 | 29.0 |
| High Temperature | 55 | 56 | 57 | 58 | 59 | 60 |
| Viscosity | | | | | | |
| A | −3.230 | −3.223 | −3.215 | −3.219 | −3.199 | −3.170 |
| B | 7017.0 | 7024.6 | 7025.0 | 7023.0 | 7015.6 | 7015.2 |
| To | 360.5 | 358.9 | 359.7 | 359.9 | 364.5 | 367.8 |
| T(200P) | 1629 | 1631 | 1633 | 1632 | 1640 | 1650 |
| T(35kP) | 1263 | 1263 | 1265 | 1265 | 1271 | 1277 |
| Isothermal hold results | 55 | 56 | 57 | 58 | 59 | 60 |
| 1180° C. crystallinity | — | — | blister on pt/no zirc | — | — | — |
| 1180° C. phase(s) | — | — | Cristobalite | — | — | — |
| 1180° C. secondary | — | — | — | — | — | — |
| phase(s) | | | | | | |
| 1190° C. crystallinity | — | — | 0% Pt/no zirc | — | — | — |
| 1190° C. phase(s) | — | — | Cristobalite | — | — | — |
| 1190° C. secondary | — | — | — | — | — | — |
| phase(s) | | | | | | |
| 1200° C. crystallinity | — | — | 0% Pt/no zirc | — | — | — |
| 1200° C. phase(s) | — | — | — | — | — | — |
| 1200 secondary phase(s) | — | — | — | — | — | — |
| 1210° C. crystallinity | — | — | 0% Pt/no zirc | — | — | — |
| 1210° C. phase(s) | — | — | — | — | — | — |
| 1210° C. secondary | — | — | — | — | — | — |
| phase(s) | | | | | | |
| Liquidus viscosity | 55 | 56 | 57 | 58 | 59 | 60 |
| Lowest isothermal pass | — | — | 1185 | — | — | — |
| (pass is <2% internal | | | | | | |
| crystals) | | | | | | |
| Liquidus viscosity (kP) | — | — | 199 | — | — | — |

Table 11 shows examples of glasses (samples 61-66)

TABLE 11

| mol % | 61 | 62 | 63 | 64 | 65 | 66 |
|---|---|---|---|---|---|---|
| SiO₂ | 69.84 | 69.70 | 69.72 | 69.82 | 69.74 | 69.52 |
| Al₂O₃ | 12.43 | 12.31 | 11.82 | 11.59 | 11.58 | 11.72 |
| B₂O₃ | 2.29 | 2.27 | 1.57 | 1.21 | 1.10 | 1.30 |
| MgO | 5.39 | 5.42 | 5.83 | 5.99 | 6.05 | 6.11 |
| CaO | 6.10 | 6.18 | 6.36 | 6.44 | 6.50 | 6.52 |
| SrO | 1.37 | 1.28 | 0.98 | 0.84 | 0.82 | 0.80 |
| BaO | 2.38 | 2.62 | 3.48 | 3.86 | 3.98 | 3.79 |
| SnO₂ | 0.10 | 0.11 | 0.11 | 0.11 | 0.11 | 0.11 |
| Fe₂O₃ | 0.01 | 0.01 | 0.01 | 0.01 | 0.01 | 0.01 |
| ZrO₂ | 0.02 | 0.02 | 0.03 | 0.02 | 0.02 | 0.02 |
| Na₂O | 0.04 | 0.05 | 0.06 | 0.07 | 0.06 | 0.06 |
| K₂O | 0.00 | 0.00 | 0.01 | 0.01 | 0.01 | 0.01 |
| TiO₂ | 0.02 | 0.02 | 0.03 | 0.03 | 0.03 | 0.03 |
| RO/Al₂O₃ | 1.23 | 1.26 | 1.41 | 1.48 | 1.50 | 1.47 |
| Physical | 61 | 62 | 63 | 64 | 65 | 66 |
| Properties | | | | | | |
| Strain Point | 735 | 736 | 737 | 737 | 736 | 733 |
| (fiber) ° C. | | | | | | |
| Annealing | 788 | 788 | 789 | 789 | 788 | 785 |
| Point (fiber) | | | | | | |
| ° C. | | | | | | |
| Strain Point | 731.5 | — | — | — | — | — |
| (BBV) ° C. | | | | | | |
| Annealing | 781.9 | — | — | — | — | — |
| Point (BBV) | | | | | | |
| ° C. | | | | | | |
| Softening | 1019.7 | — | — | — | 1015.4 | — |
| Point (fiber) | | | | | | |
| ° C. | | | | | | |
| CTE 0-300° C. | 35.1 | 35.6 | 37.4 | 38.1 | 38.5 | 38.1 |
| (10⁻⁷) | | | | | | |
| Density | 2.556 | 2.565 | — | — | 2.620 | 2.610 |
| (g/cc) | | | | | | |
| Young's | 81.2 | 83.0 | 83.3 | 83.5 | 83.3 | 83.7 |
| Modulus | | | | | | |
| (GPa) | | | | | | |
| Shear | — | — | — | — | — | — |
| Modulus | | | | | | |
| (GPa) | | | | | | |
| Poisson's | — | — | — | — | — | — |
| ratio | | | | | | |
| SOC | 29.1 | 29.1 | 28.5 | 28.2 | 28.1 | 28.2 |
| (nm/cm/MPa) | | | | | | |
| High | 61 | 62 | 63 | 64 | 65 | 66 |
| Temperature | | | | | | |
| Viscosity | | | | | | |
| A | −3.176 | −3.180 | −3.181 | −3.175 | −3.183 | −3.201 |
| B | 7012.5 | 7017.4 | 7020.6 | 7022.5 | 7018.0 | 7012.1 |
| To | 368.0 | 366.0 | 364.9 | 365.0 | 365.5 | 365.3 |
| T(200P) | 1648 | 1646 | 1646 | 1647 | 1645 | 1640 |
| T(35kP) | 1276 | 1274 | 1274 | 1275 | 1274 | 1271 |
| Isothermal | 61 | 62 | 63 | 64 | 65 | 66 |
| hold results | | | | | | |
| 1180° C. | 15% Pt/yes zirc | — | — | — | 3% Pt/yes | blister on |
| crystallinity | | | | | zirc | pt/yes zirc |
| 1180° C. | Cristobalite | — | Cristobalite | — | Cristobalite | Cristobalite |
| phase(s) | | | | | | |
| 1180° C. | Cordierite | — | Indialite | — | — | — |
| secondary | | | | | | |
| phase(s) | | | | | | |
| 1190° C. | 7% Pt/yes zirc | — | 3% Pt/yes | — | trace % Pt/no | 0% Pt/no |
| crystallinity | | | zirc | | zirc | zirc |
| 1190° C. | Cristobalite | — | Cristobalite | — | Cristobalite | Cristobalite |
| phase(s) | | | | | | |
| 1190° C. | Cordierite | — | Indialite | — | — | — |
| secondary | | | | | | |
| phase(s) | | | | | | |
| 1200° C. | trace % Pt/no | — | 0% Pt/no | — | 0% Pt/no zirc | 0% Pt/no |
| crystallinity | zirc | | zirc | | | zirc |
| 1200° C. | Cristobalite | — | Cristobalite | — | — | — |
| phase(s) | | | | | | |
| 1200° C. | Cordierite | — | — | — | — | — |
| secondary | | | | | | |
| phase(s) | | | | | | |
| 1210° C. | 0% Pt/no zirc | — | 0% Pt/no | — | 0% Pt/no zirc | 0% Pt/no |
| crystallinity | | | zirc | | | zirc |
| 1210° C. | Cristobalite | — | — | — | — | — |
| phase(s) | | | | | | |
| 1210° C. | Cordierite | — | — | — | — | — |
| secondary | | | | | | |
| phase(s) | | | | | | |
| Liquidus | 61 | 62 | 63 | 64 | 65 | 66 |
| viscosity | | | | | | |
| Lowest | 1200 | — | 1200 | — | 1190 | 1190 |
| isothermal | | | | | | |
| pass (pass | | | | | | |
| is <2% | | | | | | |
| internal | | | | | | |
| crystals) | | | | | | |
| Liquidus | 179 | — | 169 | — | 213 | 200 |
| viscosity | | | | | | |
| (kP) | | | | | | |

Table 12 shows examples of glasses (samples 67-71)

TABLE 12

| mol % | 67 | 68 | 69 | 70 | 71 |
|---|---|---|---|---|---|
| SiO₂ | 69.25 | 69.17 | 69.32 | 69.68 | 69.65 |
| Al₂O₃ | 12.13 | 12.14 | 11.99 | 11.70 | 11.64 |
| B₂O₃ | 2.00 | 2.14 | 1.96 | 1.45 | 1.32 |
| MgO | 6.11 | 6.12 | 6.06 | 6.05 | 6.10 |
| CaO | 6.57 | 6.56 | 6.54 | 6.47 | 6.48 |
| SrO | 0.71 | 0.70 | 1.06 | 1.73 | 1.95 |
| BaO | 3.03 | 2.95 | 2.86 | 2.69 | 2.64 |
| SnO₂ | 0.10 | 0.10 | 0.10 | 0.11 | 0.10 |
| Fe₂O₃ | 0.01 | 0.01 | 0.01 | 0.01 | 0.01 |
| ZrO₂ | 0.02 | 0.02 | 0.02 | 0.02 | 0.02 |
| Na₂O | 0.05 | 0.05 | 0.05 | 0.05 | 0.05 |
| K₂O | 0.00 | 0.00 | 0.00 | 0.01 | 0.01 |
| TiO₂ | 0.03 | 0.03 | 0.03 | 0.03 | 0.02 |
| RO/Al₂O₃ | 1.35 | 1.35 | 1.38 | 1.45 | 1.48 |
| Physical | 67 | 68 | 69 | 70 | 71 |
| Properties | | | | | |
| Strain Point (fiber) | 732 | 733 | 736 | 737 | 724 |
| ° C. | | | | | |
| Annealing Point | 784 | 785 | 788 | 788 | 777 |
| (fiber) ° C. | | | | | |
| Strain Point | — | 727.1 | — | — | 725.4 |
| (BBV) ° C. | | | | | |
| Annealing Point | — | 777.4 | — | — | 776.6 |
| (BBV) ° C. | | | | | |
| Softening Point | — | 1011 | — | — | 1013.6 |
| (fiber) ° C. | | | | | |
| CTE 0-300° C. | 36.5 | 36.3 | 36.7 | 37.5 | 37.8 |
| (10⁻⁷) | | | | | |
| Density (g/cc) | 2.580 | 2.570 | 2.580 | 2.590 | 2.600 |
| Young's Modulus | 83.6 | 83.4 | 83.5 | 83.8 | 83.9 |
| (GPa) | | | | | |
| Shear Modulus | — | — | — | — | — |
| (GPa) | | | | | |
| Poisson's ratio | — | — | — | — | — |
| SOC | 28.7 | 28.7 | 28.6 | 28.4 | 28.3 |
| (nm/cm/MPa) | | | | | |
| High Temperature | 67 | 68 | 69 | 70 | 71 |
| Viscosity | | | | | |
| A | −3.231 | −3.235 | −3.227 | −3.209 | −3.216 |
| B | 7001.1 | 7003.4 | 7006.2 | 7007.5 | 7004.2 |
| To | 365.28 | 364.16 | 364.15 | 365.79 | 366.04 |
| T(200 P) | 1631 | 1629 | 1632 | 1638 | 1636 |
| T(35 kP) | 1266 | 1265 | 1266 | 1270 | 1269 |
| Isothermal hold | 67 | 68 | 69 | 70 | 71 |
| results | | | | | |
| 1180° C. | — | 5% Pt/yes zirc | — | — | 100% Pt/yes |
| crystallinity | | | | | zirc |
| 1180° C. phase(s) | — | Cristobalite | — | — | Cristobalite |
| 1180° C. secondary | — | Cordeirite | — | — | — |
| phase(s) | | | | | |
| 1190° C. | — | 5% Pt/no zirc | — | — | 10% Pt/yes |
| crystallinity | | | | | zirc |
| 1190° C. phase(s) | — | Cristobalite | — | — | Cristobalite |
| 1190° C. secondary | — | Cordeirite | — | — | — |
| phase(s) | | | | | |
| 1200° C. | — | 1% Pt/no zirc | — | — | trace % Pt/no |
| crystallinity | | | | | zirc |
| 1200° C. phase(s) | — | Cristobalite | — | — | Cristobalite |
| 1200 secondary | — | | — | — | |
| phase(s) | | | | | |
| 1210° C. | — | 0% Pt/no zirc | — | — | 0% Pt/no |
| crystallinity | | | | | zirc |
| 1210° C. phase(s) | — | — | — | — | Cristobalite |
| 1210° C. secondary | — | — | — | — | — |
| phase(s) | | | | | |
| Liquidus viscosity | 67 | 68 | 69 | 70 | 71 |
| Lowest isothermal | — | 1200 | — | — | 1200 |
| pass (pass is <2% | | | | | |
| internal crystals) | | | | | |
| Liquidus viscosity | — | 139 | — | — | 152 |
| (kP) | | | | | |

The glasses provided in the present disclosure all have elastic modulus values that are at least 1% greater than that of Astra Glass and SOC values that are at least 1% lower than that of Astra. These glasses also have an anneal point that is 5° C. higher than that of Astra Glass, which will benefit overall TPV (total pitch variation).

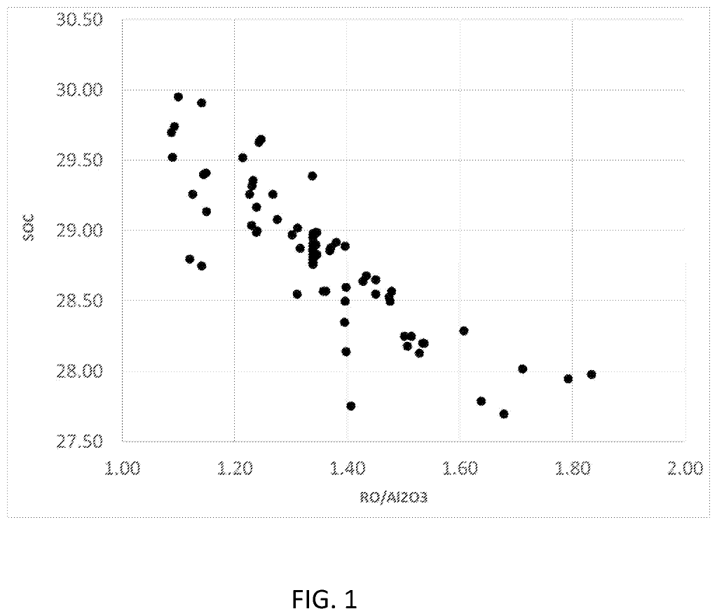

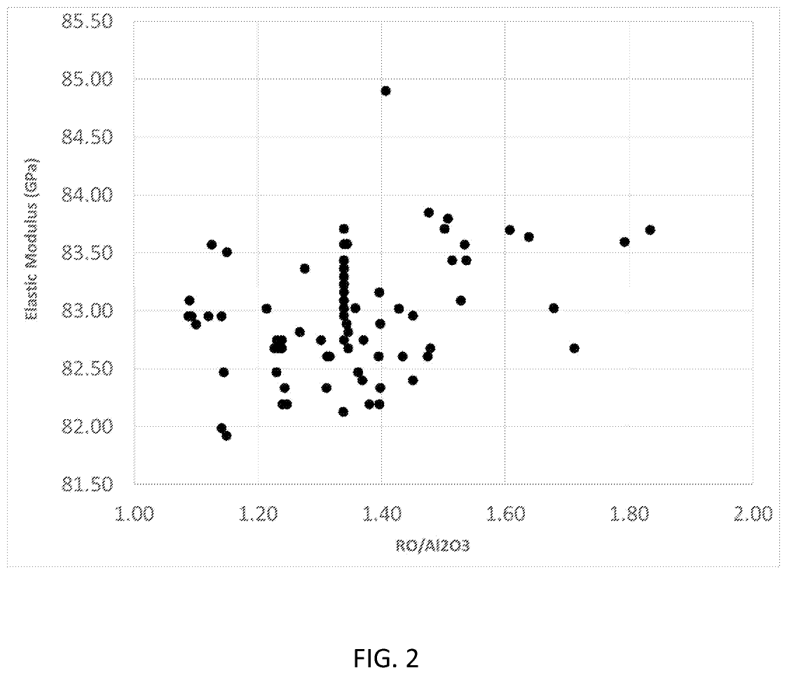

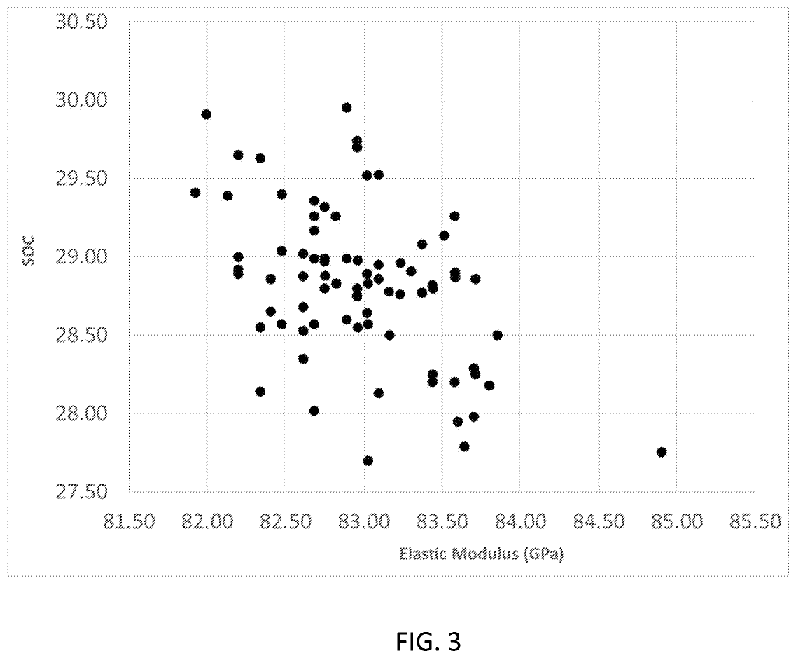

Referring to FIG. 1, the stress optical coefficient (SOC) decreases with increasing the ratio of RO/Al₂O₃. Referring to FIG. 2, the elastic modulus tends to increase with the ratio of RO/Al2O3. Referring to FIG. 3 showing the SOC as a function of the elastic modulus, the SOC goes down while the elastic modulus tends to go up.

The glass and the compositions provided in the present disclosure have significant advantages. For example, the glass compositions exhibit desirable physical properties and chemical properties, for example, improved annealing point (e.g., higher than 775° C.), improved elastic modulus, lowered stress optical coefficient (SOC), and desirable liquidus viscosity. The glass compositions are suitable for use as substrates in flat panel display devices such as active matrix liquid crystal displays (AMLCDs) with ultra-high resolution, for example, in the 8K display technology.

In another aspect, the present disclosure provides an article comprising the glass or the glass composition described herein. For example, a substrate for liquid crystal display comprises the glass or the glass composition described here.

In another aspect, the present disclosure provides a device for flat panel display, which comprises at least one sheet comprising the glass as described herein. Such a device may comprise polycrystalline silicon thin film transistors.

In another aspect, a method for producing the glass or the glass composition as described herein is provided. Such a method comprises at least one step of mixing and melting raw materials in mole percent on an oxide basis so as to provide the oxides as described. Such a method may further comprise making a sheet comprising the glass composition through a downdraw sheet fabrication process or a fusion process.

Although the subject matter has been described in terms of exemplary embodiments, it is not limited thereto. Rather, the appended claims should be construed broadly, to include other variants and embodiments, which may be made by those skilled in the art.

1. A glass comprising in mole percent on an oxide basis:
SiO₂: 68.86-70.87;
Al₂O₃: 10.55-12.643:06;
B₂O₃: 0.1-2.29;
MgO: 4.82-6.4;
CaO: 5.31-7.35;
SrO: 0.3-3.74; and
BaO: 1.5-4.64,
wherein the glass is substantially alkali-free defined by a combined concentration of Li₂O, Na₂O, and K₂O less than 0.1 mol. %,
wherein a ratio of RO/Al₂O₃ is in a range of from 1.47 to 1.83, and RO is the sum of the mole percents of MgO, CaO, SrO, and BaO, and
wherein the glass has a stress optical coefficient (SOC) in a range of from 27.70 to 28.50.

2. The glass of claim 1, wherein B₂O₃ is in a range of from 0.1 to 1.98 by mole percent.

3. The glass of claim 1, wherein B₂O₃ is in a range of from 0.5 to 1.90 by mole percent.

4. (canceled)

5. (canceled)

6. The glass of claim 1, further comprising 0.01 mol. % to 0.4 mol. % of a chemical fining agent selected from SnO₂, As₂O₃, Sb₂O₃, Fe₂O₃, CeO₂, MnO₂, F, Cl, Br, or any combination thereof.

7. The glass of claim 6, wherein the chemical fining agent comprises 0.08 mol. % to 0.13 mol. % of SnO₂.

8. The glass of claim 1, wherein the glass has an annealing point in a range from 775° C. to 810° C.

9. The glass of claim 1, wherein the glass has an annealing point in a range from 780° C. to 810° C.

10. The glass of claim 1, wherein the glass has an annealing point in a range from 785° C. to 810° C.

11. The glass of claim 1, wherein the glass has an elastic modulus in a range of from 82.47 GPa to 84.90 GPa.

12. (canceled)

13. The glass of claim 1, wherein the glass comprises
B₂O₃: 0.1-1.98;
and
has an elastic modulus in a range of from 82.47 GPa to 84.90 GPa.

14. (canceled)

15. (canceled)

16. The glass of claim 13, further comprising 0.08 mol. % to 0.13 mol. % of SnO₂ as a chemical fining agent.

17. The glass of claim 13, wherein the glass has an annealing point in a range from 775° C. to 810° C.

18. (canceled)

19. An article comprising the glass of claim 1.

20. A substrate for liquid crystal display comprising the glass of claim 1.

21. A device for flat panel display comprising at least one sheet comprising the glass of claim 1, and polycrystalline silicon thin film transistors.

22. A method for producing the glass of claim 1, comprising mixing and melting raw materials in mole percent on an oxide basis.

23. The method of claim 22, further comprising making a sheet comprising the glass through a downdraw sheet fabrication process or a fusion process.

24. The glass of claim 1, wherein the glass has an annealing point in a range from 780° C. to 791° C.

25. The glass of claim 1, wherein the ratio of RO/Al₂O₃ minus B₂O₃ in mole percent (RO/Al₂O₃—B₂O₃) is in a range of from 0 to 1.50.

26. The glass of claim 1, wherein the ratio of RO/Al₂O₃ minus B₂O₃ in mole percent (RO/Al₂O₃—B₂O₃) is in a range of from 0.22 to 1.50.

27. A glass comprising in mole percent on an oxide basis:
SiO₂: 68.86-70.87;
Al₂O₃: 10.55-12.5;
B₂O₃: 0.1-2.29;
MgO: 4.82-6.4;
CaO: 5.31-7.35;
SrO: 0.3-3.74; and
BaO: 1.5-4.64,
wherein the glass is substantially alkali-free defined by a combined concentration of Li₂O, Na₂O, and K₂O less than 0.1 mol. %,
wherein a ratio of RO/Al₂O₃ minus B₂O₃ in mole percent (RO/Al₂O₃—B₂O₃) is in a range of from 0 to 1.50, and RO is the sum of the mole percents of MgO, CaO, SrO, and BaO,
and
wherein the glass has a stress optical coefficient (SOC) in a range of from 27.70 to 28.50.

28. The glass of claim 27, wherein the ratio of RO/Al₂O₃ minus B₂O₃ in mole percent (RO/Al₂O₃—B₂O₃) is in a range of from 0.22 to 1.50.
